(19) United States
(12) Patent Application Publication
(10) Pub. No.: US 2026/0135952 A1
(43) Pub. Date: May 14, 2026

(54) COLOR MANAGEMENT METHOD, COLOR MANAGEMENT APPARATUS, STORAGE MEDIUM, IMAGE FORMING APPARATUS, AND READING APPARATUS

(71) Applicant: Konica Minolta, Inc., Tokyo (JP)

(72) Inventors: Kazuma MARUYAMA, Tokyo (JP); Masatsugu KOUGUCHI, Tokyo (JP); Hiroyuki OOYAMA, Tokyo (JP); Tomohiro OZAWA, Tokyo (JP)

(21) Appl. No.: 19/377,827

(22) Filed: Nov. 3, 2025

(30) Foreign Application Priority Data
Nov. 14, 2024 (JP) 2024-199217

(51) Int. Cl. H04N 1/00

(52) U.S. Cl. CPC H04N 1/00023; H04N 1/00005; H04N 1/00015; H04N 1/00018; H04N 1/00034; H04N 1/00045; H04N 1/0005; H04N 1/00188

(57) ABSTRACT

A color management method is for a color management apparatus that performs color management related to an image forming engine, based on data read by a reading apparatus that includes a colorimeter and a scanner installed at a conveyance path of a sheet printed by the image forming engine and that reads the printed sheet. The color management apparatus switches modes between a mode of obtaining data based on a first pattern and a mode of obtaining data based on a second pattern. For the first pattern, the colorimeter is moved in a sheet width direction by a first width and reads all or part of patches arranged in the sheet width direction. For the second pattern, the colorimeter is stationary or moves in the sheet width direction by a second width, and the scanner reads all or part of the patches arranged in the sheet width direction.

### CROSS-REFERENCE TO RELATED APPLICATIONS

The entire disclosure of Japanese Patent Application No. 2024-199217 filed on November 14, 2024, is incorporated herein by reference in its entirety.

### BACKGROUND OF THE INVENTION

### TECHNICAL FIELD

The present disclosure relates to a color management method, a color management apparatus, a storage medium, an image forming apparatus, and a reading apparatus.

### DESCRIPTION OF RELATED ART

A known image forming apparatus reads a sheet on which a chart has been printed using a reading apparatus (inline reading apparatus) provided at a sheet conveyance path to perform color management. Such an image forming apparatus can automatically perform a series of processes, such as printing a chart, colorimetry of the chart, and color management based on colorimetry data. For example, in response to a predetermined operation by the user, the image forming apparatus performs the series of processes. Therefore, even an unskilled operator can perform color management of the image forming apparatus with respect to color matching jobs, such as color verification and color correction.

A recent inline reading apparatus includes both a scanner (e.g., a linear CCD sensor) and an optical colorimeter movable in a sheet width direction (CD direction) perpendicular to a sheet conveyance direction (see Japanese Unexamined Patent Publication No. 2024-85279). The scanner has a higher reading speed but is less accurate with respect to colorimetric values than the optical colorimeter. This is because the scanner calculates colorimetric values (e.g., L*a*b* values, XYZ-values) from read data (RGB values). On the other hand, the colorimeter is more accurate with respect to colorimetric values but has a lower reading speed. This is because the colorimeter itself needs to move in the sheet width direction to perform reading. The operator is required to make full use of the scanner and the colorimeter to meet customer needs regarding color matching.

### SUMMARY OF THE INVENTION

A print shop or the like that performs printing for customers are often required to provide high-quality printed materials in a short time. However, the quality and the delivery date are incompatible, and it is difficult to achieve both high quality and short delivery time. Therefore, when receiving an order, the operator needs to ask a customer about the quality and the delivery date and perform color matching jobs, based on the balance between the quality and the delivery date required by the customer.

The inline reading apparatus was originally intended to automate the color matching procedure so that an operator with little knowledge or experience could efficiently perform color management. However, an operator with little knowledge or experience may find it difficult to fully use the scanner and the colorimeter to meet the balance between the quality and the delivery date required by the customer.

The present disclosure has been made in consideration of the above challenge in the related art. An object of the present disclosure is to perform color management to meet a required balance between quality and delivery date.

To achieve at least one of the abovementioned objects, according to an aspect of the present invention, there is provided a color management method for a color management apparatus that performs color management related to an image forming engine, based on data read by a reading apparatus that includes a colorimeter and a scanner installed at a conveyance path of a sheet printed by the image forming engine and that reads the printed sheet, wherein: the color management apparatus switches modes between a mode of obtaining data based on a first pattern and a mode of obtaining data based on a second pattern; for the first pattern, the colorimeter is moved in a sheet width direction by a first width and reads all or part of patches arranged in the sheet width direction; and for the second pattern, the colorimeter is stationary in the sheet width direction or moves in the sheet width direction by a second width narrower than the first width, and the scanner reads all or part of the patches arranged in the sheet width direction.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 illustrates a configuration of a color management system in a first embodiment of the present disclosure;

FIG. 2 illustrates a hardware configuration of an image forming apparatus;

FIG. 3 illustrates a hardware configuration of a reading apparatus;

FIG. 4 illustrates an external appearance of the image forming apparatus and the reading apparatus;

FIG. 5 schematically illustrates a positional relationship between an inline reading section and a chart;

FIG. 6 illustrates a hardware configuration of a PC;

FIG. 7 illustrates a hardware configuration of a printer controller;

FIG. 8 illustrates a hardware configuration of a color management apparatus;

FIG. 9 illustrates an example of the data configuration of a printer information table;

FIG. 10 illustrates an example of the data configuration of a color management dataset table;

FIG. 11 is an example of a chart formed by a pattern A;

FIG. 12 is an example of a chart formed by a pattern B;

FIG. 13 is an example of a chart formed by a pattern C;

FIG. 14 is an example of a chart formed by a pattern D;

FIG. 15 is an example of a chart formed by a pattern E;

FIG. 16 is a diagram for explaining spot colorimetry by a colorimeter;

FIG. 17 is a diagram for explaining line colorimetry by the colorimeter;

FIG. 18 is a flowchart of a first color management process;

FIG. 19 illustrates a data configuration of sheet print setting information;

FIG. 20 is an example of a colorimetry setting screen;

FIG. 21 is a flowchart of a second color management process in a second embodiment;

FIG. 22 is an example of a screen for selecting a color management dataset;

FIG. 23 is an example of a chart that includes an accuracy-prioritized pattern and a speed-prioritized pattern in the same page;

FIG. 24 is an example of a chart that is formed of multiple pages and includes an accuracy-prioritized pattern and a speed-prioritized pattern;

FIG. 25 is an example of a case where, in a chart formed of multiple pages, the switching position between the accuracy-prioritized pattern and the speed-prioritized pattern is in one page;

FIG. 26 is an example of a colorimetry setting screen that allows setting of the ratio between the accuracy-prioritized pattern and the speed-prioritized pattern;

FIG. 27 is an example of a colorimetry setting screen on which a pattern and a ratio to be used can be set; and

FIG. 28 is an example of the priority order of patches.

### DETAILED DESCRIPTION

Hereinafter, one or more embodiments of the present invention will be described with reference to the drawings. However, the scope of the invention is not limited to the disclosed embodiments.

In the following, embodiments of the present disclosure will be described with reference to the drawings. The advantages and features provided by the embodiments will be understood from the following detailed description and the drawings. However, the scope of the present disclosure is not limited to the embodiments disclosed below or the illustrated examples.

### First Embodiment

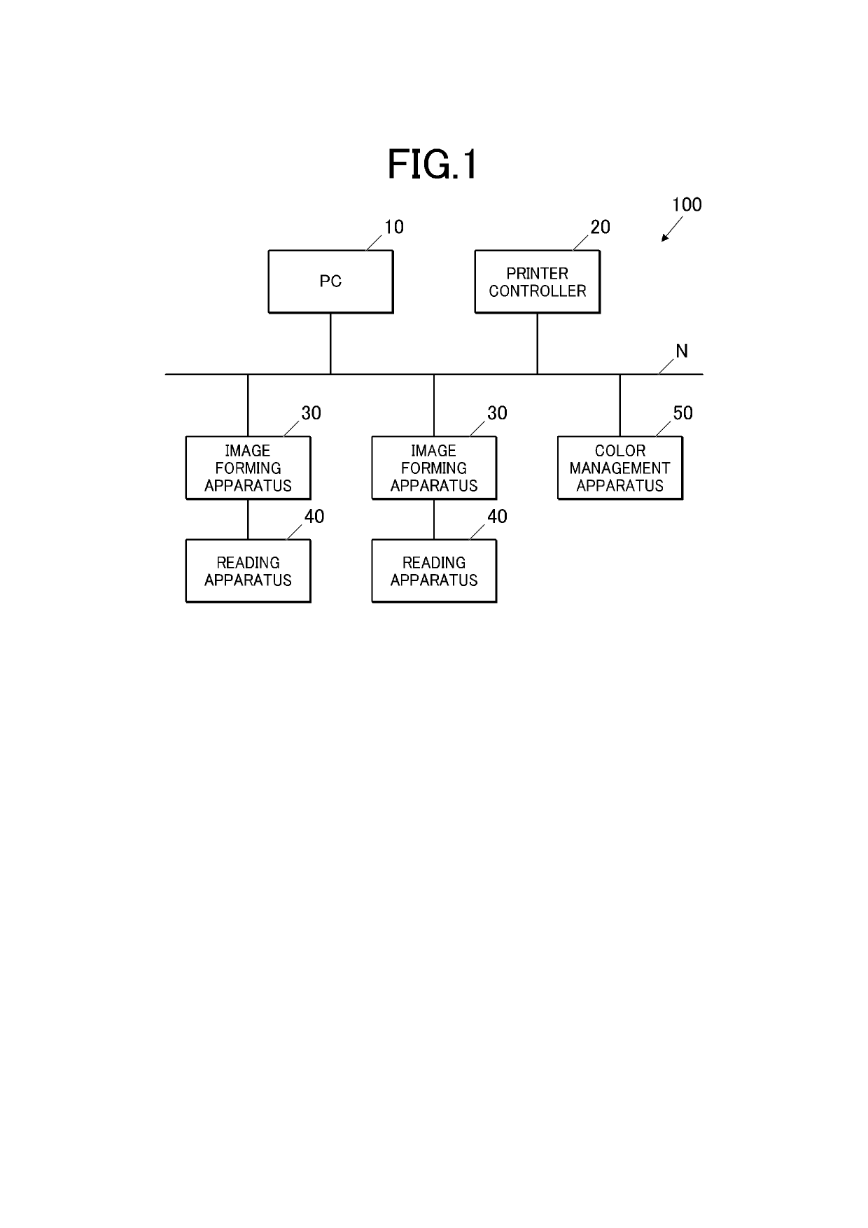

FIG. 1 shows a configuration of a color management system 100 according to a first embodiment. The color management system 100 includes a personal computer (PC) 10, a printer controller 20, image forming apparatuses 30, reading apparatus 40 corresponding to the respective image forming apparatuses 30, and a color management apparatus 50. The apparatuses constituting the color management system 100 are connected via a communication network, such as a local area network (LAN), to perform data communication. The number of apparatuses/devices is not particularly limited. The color management system 100 is used, for example, in a print shop that provides printed materials to customers.

Each of the image forming apparatuses 30 may be connected to the corresponding reading apparatus 40 via a dedicated line. In this case, the reading apparatus 40 performs data communication with the other apparatuses via the image forming apparatus 30.

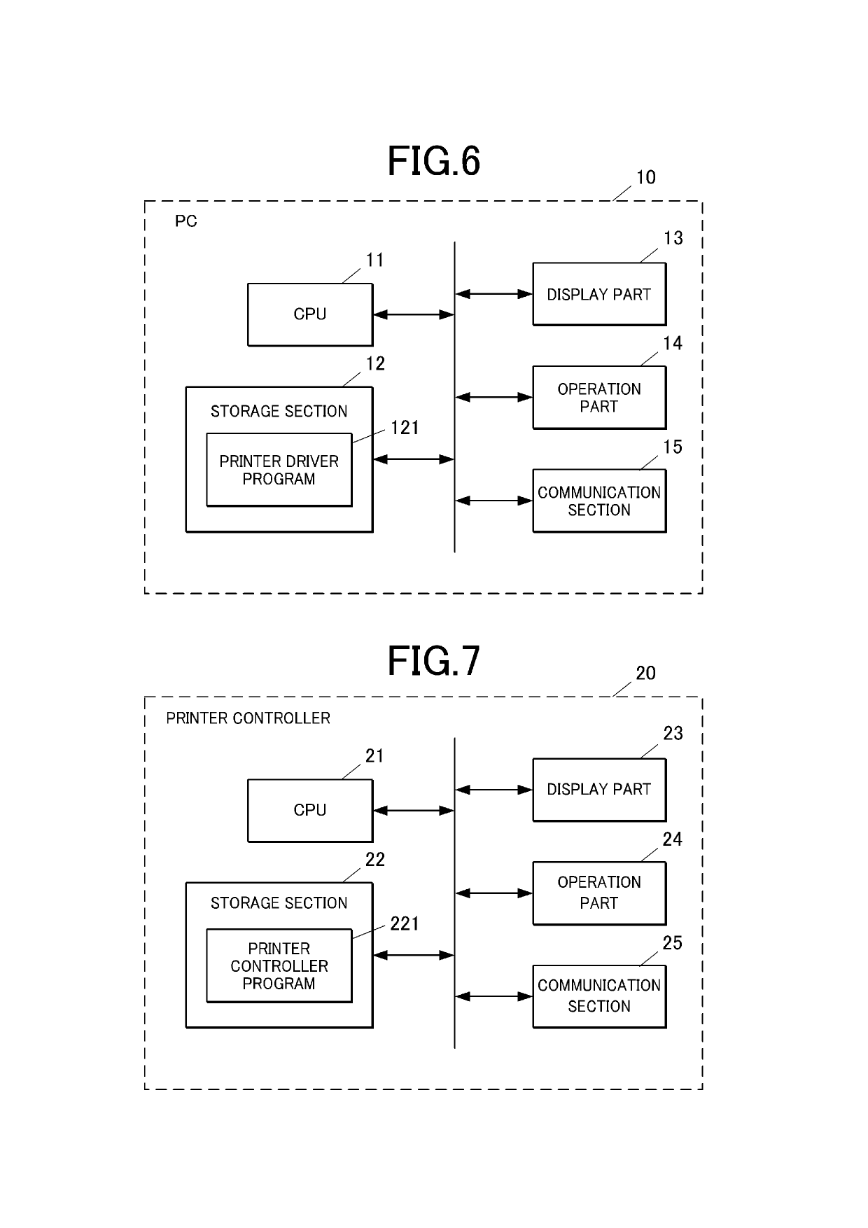

A printer driver program 121 (see FIG. 6) is installed in the PC 10. With the printer driver, the PC 10 instructs the printer controller 20 or the forming apparatus 30 to perform printing. Specifically, the PC 10 generates print data described in a page description language (PDL) interpretable by the printer controller 20 in response to a user operation. For another example, the PC may not use the printer driver but may use a specific application to instruct the printer controller 20 or the image forming apparatus 30 to perform printing of data, such as PDF data.

A printer controller program 221 (see FIG. 7) is installed in the printer controller 20. The printer controller 20 receives print data from the PC 10. Further, the printer controller 20 receives chart data from the color management apparatus 50. The printer controller 20 performs raster image processing (RIP) on the print data or the chart data to generate image data for printing (raster data). Further, the printer controller 20 performs image processing, such as color conversion and screening, on the image data for printing. The printer controller 20 transmits the image data after image processing (raster data) to the image forming apparatus 30.

The printer controller 20 may be built in the image forming apparatus 30. The printer controller 20 and the image forming apparatus 30 may be connected to each other via a dedicated line, such as a PCI connection.

The image forming apparatus 30 forms images on sheets, based on the raster data (image data in a bitmap format) received from the printer controller 20. The sheets include printing sheets and various films. Examples of sheet types include plain paper, high-quality paper, gloss coated paper, and matt coated paper.

The reading apparatus 40 is connected downstream of the image forming apparatus 30 in the sheet conveyance direction. The reading apparatus 40 reads the sheet on which printing has been performed by the image forming apparatus 30.

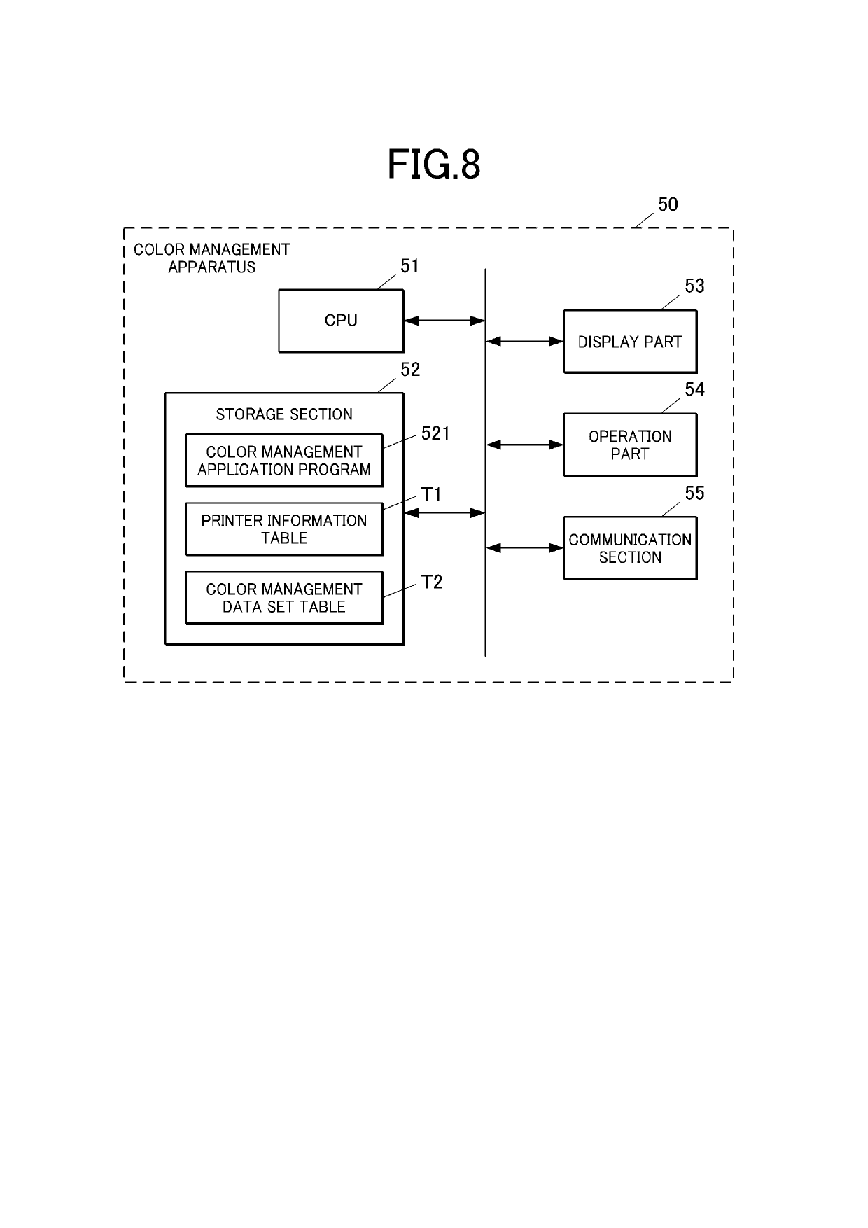

A color management application program 521 (see FIG. 8) for performing color management of the image forming apparatus 30 is installed in the color management apparatus 50. The color management apparatus 50 performs color verification, color profile creation, color correction, history management, and so forth for the image forming apparatus 30.

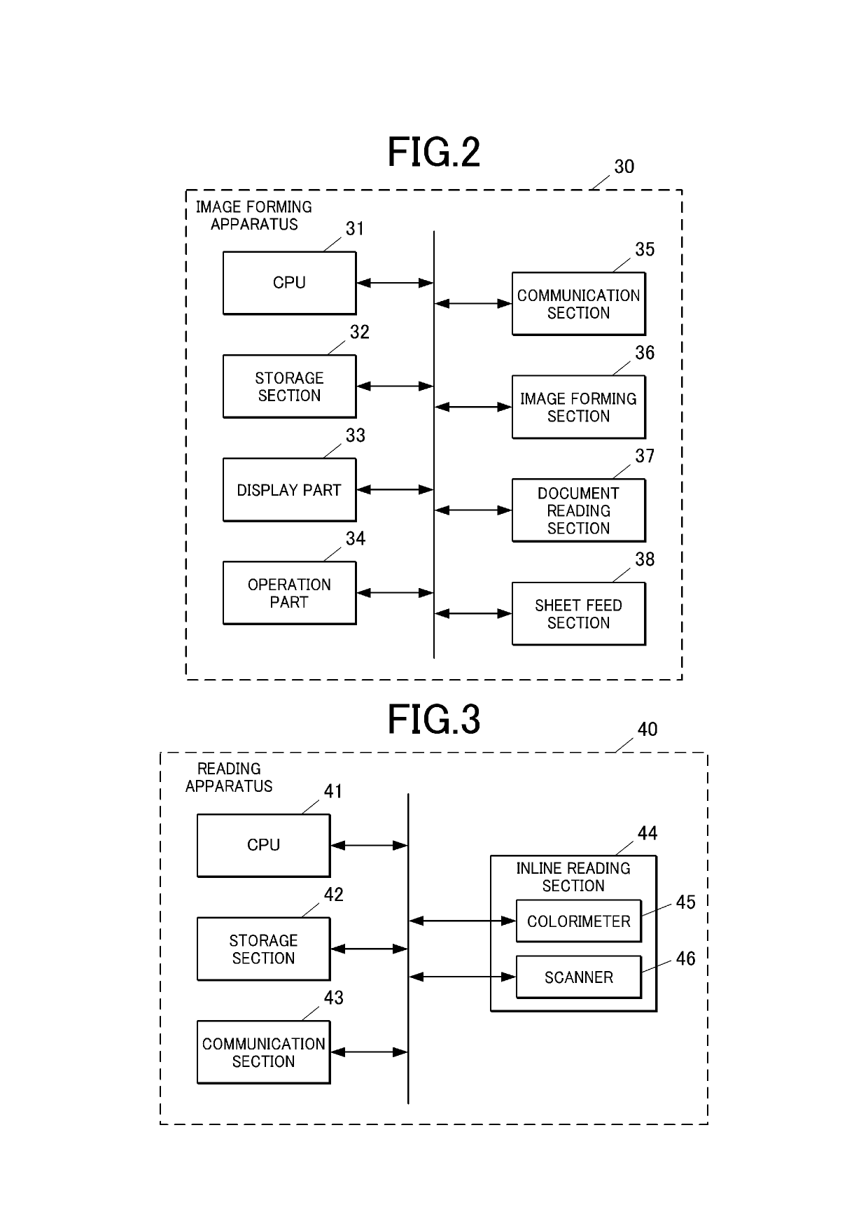

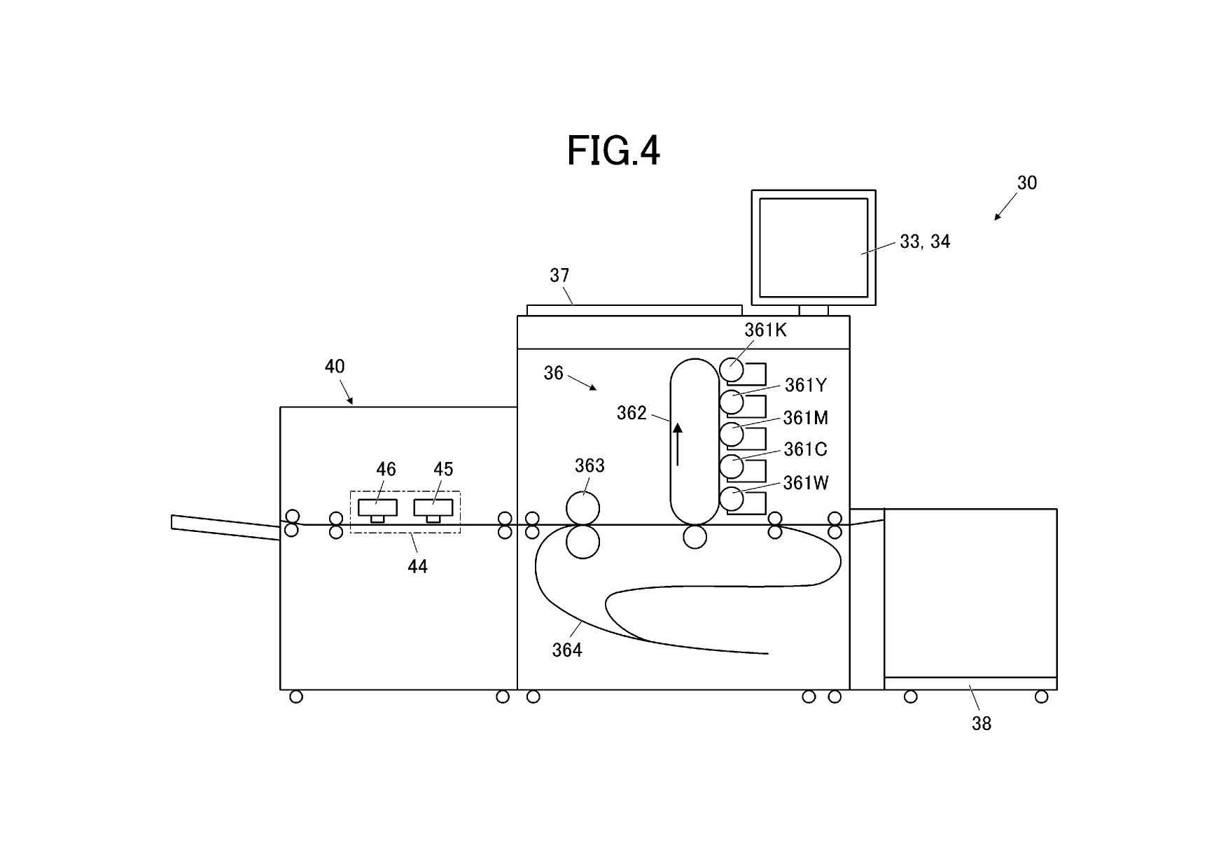

FIG. 2 shows a hardware configuration of the image forming apparatus 30. FIG. 3 shows a hardware configuration of the reading apparatus 40. FIG. 4 shows an external configuration of the image forming apparatus 30 and the reading apparatus 40. The image forming apparatus 30 is capable of forming images using toner in white (W), which is a special color, in addition to toner in four colors of cyan (C), magenta (M), yellow (Y), and black (K).

As illustrated in FIG. 2, the image forming apparatus 30 includes a central processing unit (CPU) 31, a storage section 32, a display part 33, an operation part 34, a communication section 35, an image forming section 36, a document reading section 37, and a sheet feed section 38.

The CPU 31 centrally controls processing operations of each section of the image forming apparatus 30. The CPU 31 reads various processing programs stored in the storage section 32 and performs various kinds of processing in cooperation with the programs.

The storage section 32 includes a hard disk drive (HDD), a solid-state drive (SSD), and/or a non-volatile memory. The storage section 32 stores various processing programs, data related to various kinds of processing, and so forth. For example, the storage section 32 stores sheet information related to the image forming apparatus 30. Further, the storage section 32 stores a target profile, a printer profile, a scanner profile, and so forth.

The display part 33 consists of a liquid crystal display (LCD). The display part 33 displays various screens in accordance with instructions of display signals input by the CPU 31.

The operation part 34 receives various operations by a user and outputs operation signals based on the operations to the CPU 31. The operation part 34 includes a touch screen, a numeric keypad, a start button, and a stop button.

The communication section 35 performs data communication with external devices. For example, the communication section 35 receives raster data from the printer controller 20. The communication section 35 receives a print instruction and the like from the color management apparatus 50.

The image forming section 36 forms an image on a sheet by the electrophotographic method. As illustrated in FIG. 4, the image forming section 36 includes photosensitive drums 361C, 361M, 361Y, 361K, and 361W corresponding to the respective colors of cyan (C), magenta (M), yellow (Y), black (K), and white (W), an intermediate transfer belt 362, a fixing section 363, and a reversing section 364. For example, the image forming section 36 uniformly charges the photosensitive drum 361C corresponding to cyan and scans and exposes the photosensitive drum 361C with a laser beam, based on image data of cyan to form an electrostatic latent image. The image forming section 36 causes the cyan toner to adhere to the electrostatic latent image on the photosensitive drum 361C, thereby developing the image. The same process is performed for the other colors. The image forming section 36 sequentially transfers the toner images of the respective colors formed on the photosensitive drums 361C, 361M, 361Y, 361K, and 361W onto the intermediate transfer belt 362 (primary transfer). That is, a color toner image consisting of superposed toner images of multiple colors is formed on the intermediate transfer belt 362. The image forming section 36 collectively transfers the color toner image on the intermediate transfer belt 362 onto a sheet (secondary transfer). The fixing section 363 fixes the color toner image on the sheet by applying heat and pressure. When images are formed on both sides of the sheet, the reversing section 364 reverses the sheet on which the image has been fixed on the front side and conveys the sheet again to the image forming section 36. The CPU 31 controls the image forming section 36 based on the raster data received from the printer controller 20 to form an image.

FIG. 4 illustrates the image forming section 36 that forms images using toner in five colors of cyan, magenta, yellow, black, and white (CMYKW) as an example. For another example, the toner used by the image forming section 36 may not include white or may include a special color other than white.

The document reading section 37 reads a sheet, a color sample, or the like placed on a document plate and generates read data having pixel values of the respective colors of red (R), green (G), and blue (B).

The sheet feed section 38 includes multiple sheet feed trays and feeds sheets stored in each sheet feed tray to the image forming section 36.

As illustrated in FIG. 3, the reading apparatus 40 includes a CPU 41, a storage section 42, a communication section 43, and an inline reading section 44.

The CPU 41 centrally controls processing operations of each section of the reading apparatus 40. The CPU 41 reads various processing programs stored in the storage section 42 and performs various kinds of processing in cooperation with the programs.

The storage section 42 includes an HDD, an SSD, and/or a nonvolatile memory. The storage section 42 stores various processing programs, data related to various kinds of processing, and so forth.

The communication section 43 performs data communication with external devices. For example, the communication section 43 receives an instruction to read a chart from the color management apparatus 50. The communication section 43 transmits the data read by the inline reading section 44 to the color management apparatus 50.

The inline reading section 44 is provided at the conveyance path on the downstream side of the image forming section 36 (image forming engine) in the sheet conveyance direction. The inline reading section 44 reads an image formed on a sheet and generates read data. The inline reading section 44 includes a colorimeter 45 and a scanner 46.

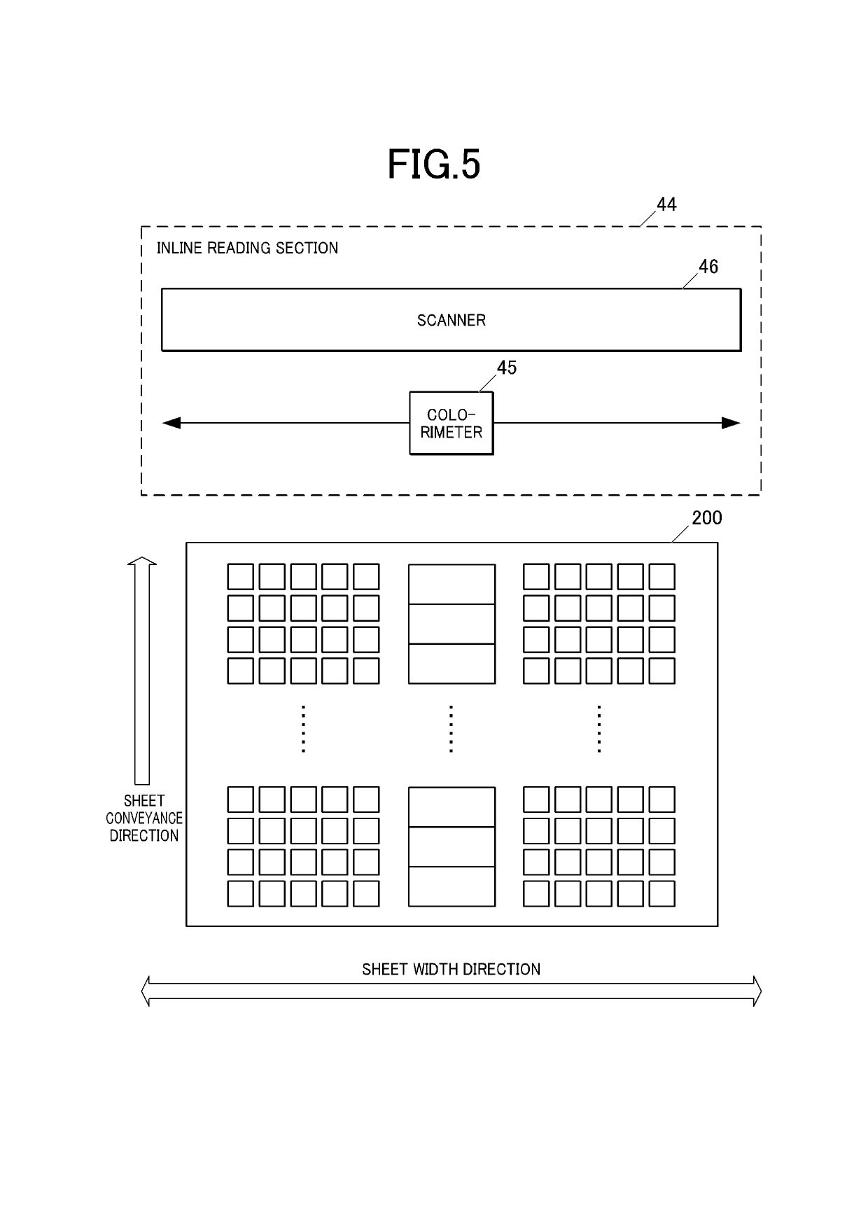

FIG. 5 schematically illustrates the positional relationship between the inline reading section 44 and the chart 200. As the chart 200 is conveyed, the inline reading section 44 can read different positions on the chart 200 in the sheet conveyance direction.

The colorimeter 45 is a spectral colorimeter and accurately measures the absolute values of colors (e.g., L*a*b* values, XYZ values). The colorimeter 45 detects the spectral reflectance of an image formed on a sheet (chart 200) for each wavelength to measure the colors of the image. The colorimeter 45 is configured to perform a spot colorimetry mode and a line colorimetry mode.

In the spot colorimetry mode, colorimetry is performed on each individual patch one by one. The spot colorimetry mode is like pressing the shutter button of a camera once for each patch. That is, in the spot colorimetry mode, the colorimeter 45 reads a partial area of the sheet in the sheet width direction (main scanning direction), which is perpendicular to the sheet conveyance direction, by one time of reading (one time of colorimetry).

In the line colorimetry mode, reading is performed while moving the colorimeter 45, so that time-series data of colorimetric values is obtained. The line colorimetry mode is like moving a camera with its shutter open. In the line colorimetry mode, the colorimeter 45 may output an average value of colorimetric values obtained from the same patch as the read data corresponding to the patch.

The colorimeter 45 is movable in the sheet width direction. The colorimeter 45 can read the entire sheet width by being moved in the sheet width direction. That is, the colorimeter 45 can read only part of the sheet in the sheet width direction unless being moved. The colorimeter 45 is also used for correction (calibration) of the scanner 46.

The scanner 46 is fixed and can read the entire sheet width direction by one time of reading. The scanner 46 reads a conveyed sheet (chart 200) and generates read data having pixel values of the respective colors of red (R), green (G), and blue (B). The scanner 46 is, for example, a linear CCD sensor. Based on the RGB values from the reading of the scanner 46, the CPU 31 calculates colorimetric values (e.g., L*a*b* values, XYZ values).

Patterns (charts) to be read by the inline reading section 44 include a first pattern and a second pattern.

For the first pattern, the colorimeter 45 moves by a first width in the sheet width direction and reads all or part of the patches arranged in the sheet width direction. The first pattern, in which the colorimeter 45 mainly performs reading, is referred to as an accuracy-prioritized pattern. Reading of the accuracy-prioritized pattern is more accurate in colorimetry but slower than reading of the second pattern. In reading the accuracy-prioritized pattern, the colorimeter 45 reads about 1,700 patches printed on the entire surface of the sheet and performs color adjustment, for example. Thus, accurate color management is performed.

For the second pattern, the colorimeter 45 is stationary or moves by a second width narrower than the first width in the sheet width direction; and the scanner 46 reads all or part of the patches arranged in the sheet width direction. The second pattern, in which the scanner 46 mainly performs reading, is referred to as a speed-prioritized pattern. Reading of the speed-prioritized pattern is faster but less accurate in colorimetry than reading of the accuracy-prioritized pattern.

Note that the accuracy-prioritized pattern and the speed-prioritized pattern are relative expressions. Depending on the patterns to be compared, a pattern can be either the accuracy-prioritized pattern or the speed-prioritized pattern.

FIG. 6 illustrates a hardware configuration of the PC 10. The PC 10 includes a CPU 11, a storage section 12, a display part 13, an operation part 14, and a communication section 15.

The CPU 11 centrally controls processing operations of each section of the PC 10. The CPU 11 reads various processing programs stored in the storage section 12 and performs various kinds of processing in cooperation with the programs.

The storage section 12 includes an HDD, an SSD, and/or a non-volatile memory. The storage section 12 stores various processing programs such as a printer driver program 121, data related to various processes, and so forth.

The display part 13 consists of an LCD. The display part 13 displays various screens in accordance with instructions of display signals input by the CPU 11.

The operation part 14 includes a keyboard and a pointing device, such as a mouse. The operation part 14 outputs, to the CPU 11, operation signals input by key operations on the keyboard and operations on the pointing device.

The communication section 15 performs data communication with external devices.

FIG. 7 shows a hardware configuration of the printer controller 20. The printer controller 20 includes a CPU 21, a storage section 22, a display part 23, an operation part 24, and a communication section 25. The sections of the printer controller 20 are similar to the sections of the PC 10. Aspects of the printer controller 20 different from the printer controller PC 10 will be described.

The storage section 22 stores a printer controller program 221. The storage section 22 also stores a target profile, a printer profile, and so forth.

FIG. 8 shows a hardware configuration of the color management apparatus 50. The color management apparatus 50 includes a CPU 51 (hardware processor), a storage section 52, a display part 53, an operation part 54, and a communication section 55. Since each unit in the color management apparatus 50 is the same as each unit in the PC 10, the parts different from the PC 10 will be described.

The storage section 52 stores a color management application program 521. A color management application is realized by the CPU 51 in cooperation with the color management application program 521. The color management application provides a user interface for giving an instruction to perform color management of the image forming apparatus 30, confirming a color verification result, calculating a correction value, and so forth. The use of the color management application is not limited to the case where the program is locally installed. For another example, the color management apparatus 50 may use the color management application on a cloud via a browser by using a software as a service (SaaS).

The storage section 52 stores a printer information table T1 and a color management dataset table T2.

The printer information table T1 is a table for managing printer information on multiple image forming apparatuses 30 in the color management system 100.

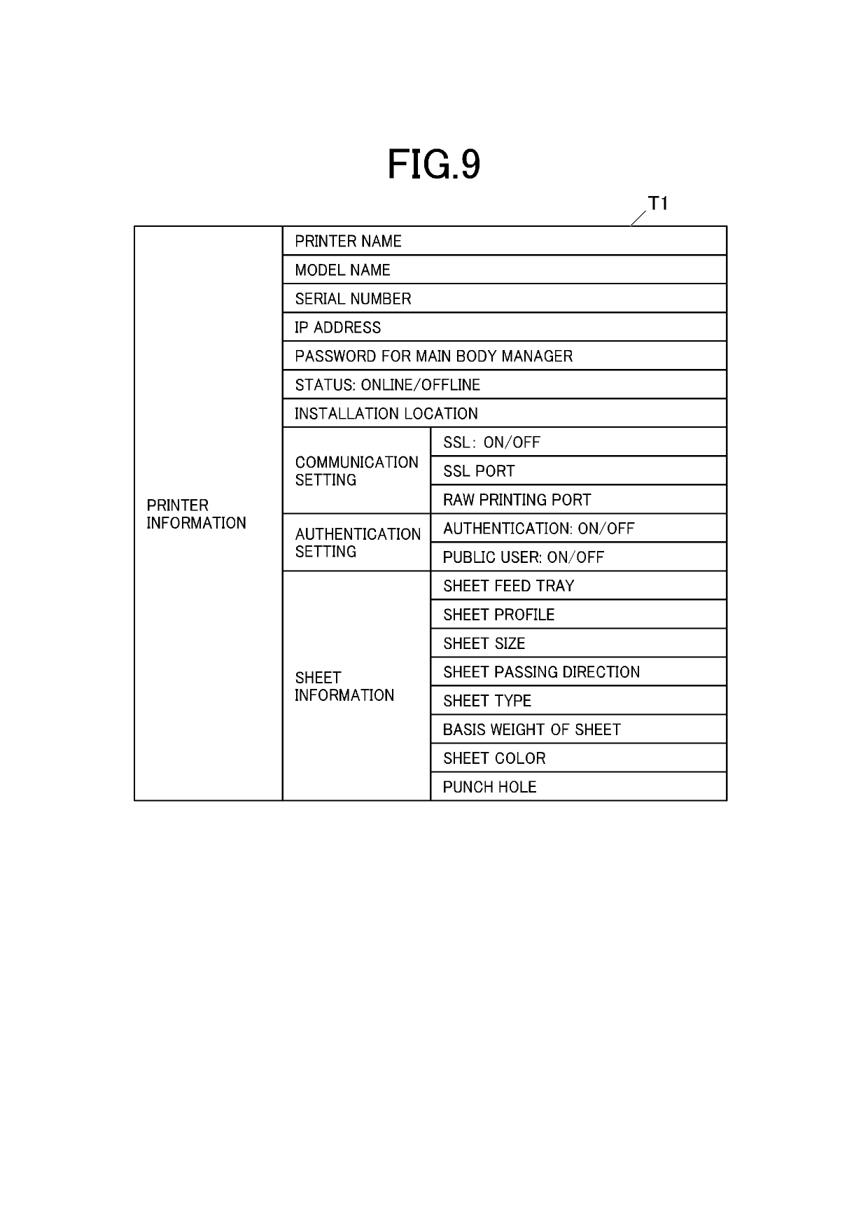

FIG. 9 shows an example of the data structure of the printer information table T1. The printer information table T1 stores the printer name, model name, serial number, IP address, password for main body manager, status, installation location, communication setting, authentication setting, sheet information, and so forth in association with each of the image forming apparatuses 30.

The "printer name" indicates the name of an image forming apparatus 30 (printer).

The "model name" indicates the model name of the image forming apparatus 30.

The "serial number" is the serial number of the image forming apparatus 30.

The "IP address" is the IP address of the image forming apparatus 30. As the "IP address", the IP address of the image forming engine (image forming apparatus 30) and the IP address of the printer controller 20 may be managed.

The “password for main body manager" is the password of the image forming apparatus 30 for the main body manager.

The "Status" is information indicating a state of the image forming apparatus 30. The "status” may indicate whether the image forming apparatus 30 is online or offline.

The "installation location" indicates an installation location of the image forming apparatus 30.

The "communication setting" is information on the communication setting of the image forming apparatus 30. The "communication setting" includes SSL (ON or OFF), an SSL port, and an RAW print port.

The "authentication setting" is information indicating the authentication setting of the image forming apparatus 30. The "authentication setting" includes authentication (ON or OFF) and a public user (ON or OFF).

The "sheet information" is information on the sheet to be used by the image forming apparatus 30. The "sheet information" is information indicating the sheet type, the sheet feed tray that houses the sheet, and so forth. The "sheet information" includes a sheet feed tray, sheet profile, sheet size, sheet passing direction, sheet type, sheet basis weight, sheet color, and punch hole.

The color management dataset table T2 is a table for managing color management datasets (target configuration and color management goal setting) to be used by the color management apparatus 50 (color management application). The color management dataset includes settings of a colorimeter used for color management, settings of a chart to be used, allowable values of color verification, settings for color correction, and settings of a data obtaining mode. The color management dataset includes various settings necessary for the colorimetry process.

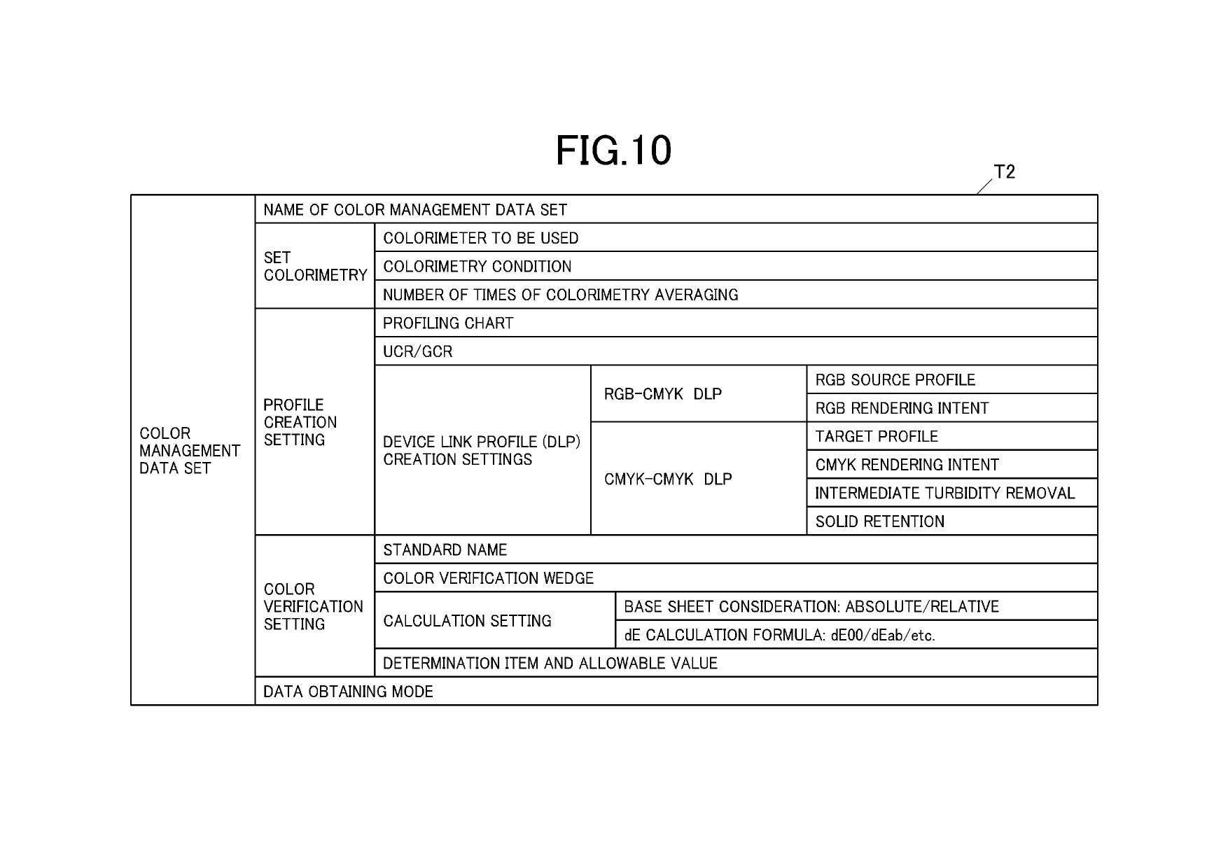

FIG. 10 shows an example of the data structure of the color management dataset table T2. The color management dataset table T2 stores a color management dataset name, colorimetry setting, profile creation setting, color verification setting, data obtaining mode, and so forth in association with each color management dataset.

The "color management dataset name" is the name of the color management dataset.

The "colorimetry setting" is the setting related to colorimetry. The "colorimetry setting" includes a colorimeter to be used, colorimetry conditions, and the number of times of colorimetry averaging.

In obtaining colorimetric values, multiple wedges or charts are printed in consideration of printing stability, and the colorimetric values are averaged for each patch. The "number of times of colorimetry averaging" is the number of copies of a wedge or a chart used for the averaging. The "number of times of colorimetry averaging" is a value specified by the user.

The "profile creation setting" is the setting related to creation of a profile. The "profile creation setting" includes creation settings of a profiling chart, UCR/GCR, and device link file (DLP).

The "profiling chart" is a chart to be used for creating a profile (profiling).

The "UCR (Under Color Removal)” is to replace CMY in a shadow portion with black (K). The "GCR (Gray Component Replacement)” is to replace CMY in both the highlight parts and the shadow parts (i.e., in all the gradation parts) with black (K).

The "DLP creation setting" includes RGB-CMYK DLP (RGB source profile, RGB rendering intent) and CMYK-CMYK DLP (target profile, CMYK rendering intent, intermediate turbidity removal, and solid retention).

The "intermediate turbidity removal" is the setting for reproducing a color that consisted of a single color before color conversion so as to consist of the single color after color conversion.

The "solid retention" is the setting for reproducing a part that was solid before color conversion with the solid color after color conversion.

The "color verification setting" is the setting related to color verification. The "color verification setting" includes a color verification standard name, color verification wedge, calculation setting, determination item, and allowable value.

The "calculation setting" includes base sheet consideration (absolute/relative) and a dE calculation formula (e.g., dE00, dEab).

The "determination item and allowable value" are a determination item and its allowable value defined by the standard. The "determination item and allowable value" may be strict or loose according to the user.

The "data obtaining mode" is a mode in which the image forming apparatus 30 obtains data from the reading apparatus 40 color management.

The CPU 51 obtains the data read by the inline reading section 44 from the reading apparatus 40 via the communication section 55. The read data is L*a*b* data when it is read by the colorimeter 45, The read data is RGB data and/or L*a*b* data when it is read by the scanner 46. The L^{*}a^{*}b* values may be replaced by other values representing colors, such as XYZ values or density values.

The CPU 51 (controller) performs color management of the image forming apparatus 30 (image forming engine), based on the data read by the inline reading section 44 (reading apparatus 40) installed at the conveyance path of the sheet on which printing has been performed by the image forming apparatus 30. The color management is at least one of color verification, color profile creation, and color correction.

Color verification is a function of comparing the actual reading result of a chart printed by the image forming apparatus 30 with a target value and verifying whether the reading result satisfies a color verification standard.

Color profile creation is a function of creating a profile that indicates color characteristics of the image forming apparatus 30.

Color correction is a function of correcting a color to be printed by the image forming apparatus 30.

The CPU 51 switches modes between a mode of obtaining data based on the accuracy-prioritized pattern (first pattern) and a mode of obtaining data based on the speed-prioritized pattern (second pattern). The data based on the accuracy-prioritized pattern includes not only data directly obtained by the reading apparatus 40 reading the accuracy-prioritized pattern but also data obtained by performing processing (e.g., color conversion) on the data obtained by reading the accuracy-prioritized pattern. The same applies to the data based on the speed-prioritized pattern.

It is assumed that the length and width (dimensions in the sheet conveyance direction and in the sheet width direction) of each patch are determined beforehand between the image forming apparatus 30 and the color management application. For example, the size of a patch to be read by the colorimeter is 10 to 20 mm × 10 to 20 mm, and the size of a patch to be read by the scanner 46 is 10 mm × 10 mm.

The data obtained by the CPU 51 is classified into data read by the colorimeter 45 and data read by the scanner 46 and retained.

A pattern A is an example of the accuracy-prioritized pattern. In the pattern A, the colorimeter 45 reads all the patches arranged in the sheet width direction. For another example, in the pattern A, part of the patches arranged in the sheet width direction may not be read by the colorimeter 45.

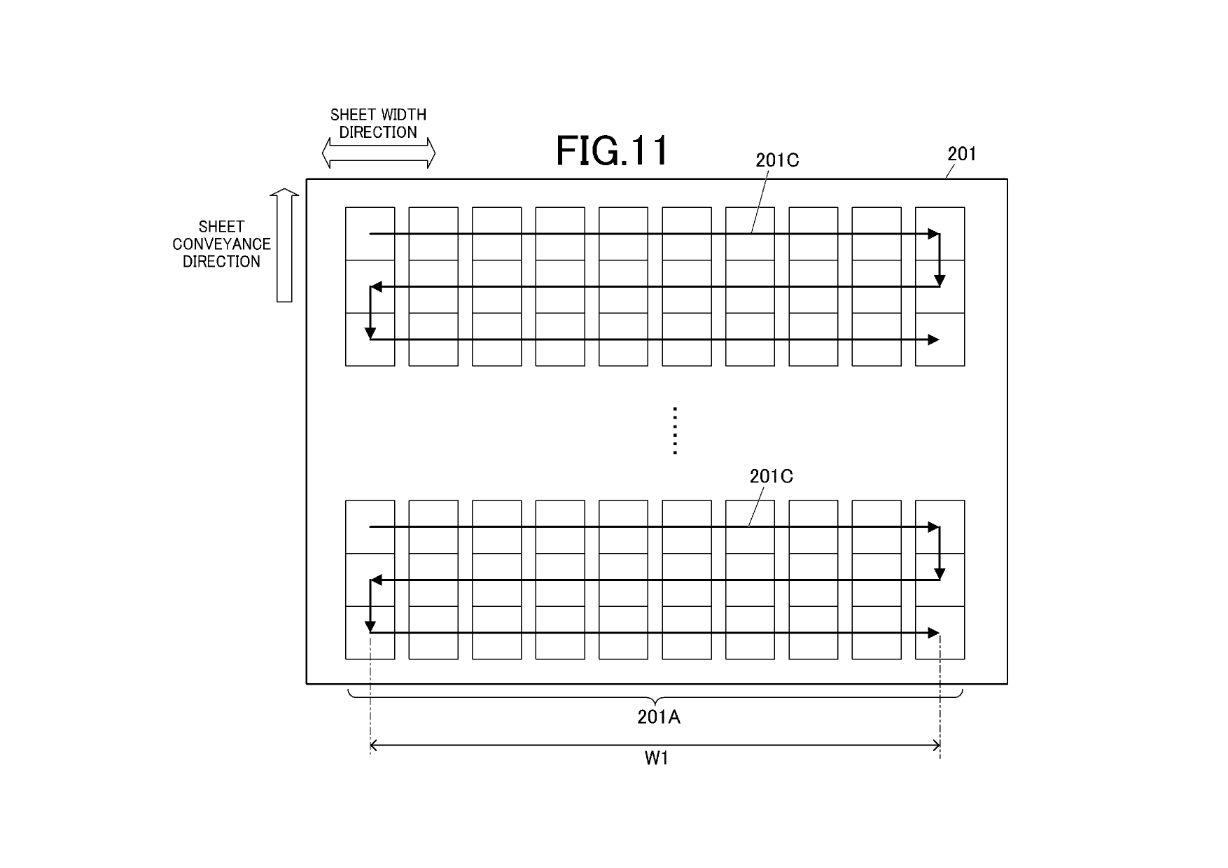

FIG. 11 illustrates an example of a chart 201 for the pattern A. In the pattern A, the CPU 51 of the color management apparatus 50 performs color management using only the read data by the colorimeter 45. The CPU 41 of the reading apparatus 40 performs colorimetry while moving the colorimeter 45 in the sheet width direction so that the colorimeter 45 reads all the patches in the chart 201. The area 201A of the chart 201 is the reading target of the colorimeter 45. For example, the width W1 in FIG. 11 corresponds to the first width by which the colorimeter 45 moves in the sheet width direction in reading the pattern A. FIG. 11 illustrates the width W1 on the assumption that the colorimeter 45 reads the central position of each patch in the sheet width direction. The arrow 201C in FIG. 11 indicates the reading order of the patches by the colorimeter 45.

The data of each patch read by the colorimeter 45 is obtained by a spectral colorimeter. The CPU 41 of the reading apparatus 40 obtains the data of each patch read by the colorimeter 45. For each patch, the CPU 41 outputs an L*a*b* value, density value, wavelength characteristics, or the like.

In the pattern A, the CPU 51 of the color management apparatus 50 obtains data of each patch read by the colorimeter 45 (e.g., L*a*b* value, density value, wavelength characteristics) but does not obtain data read by the scanner 46.

A pattern B is an example of the accuracy-prioritized pattern. In the pattern B, the colorimeter 45 reads part of the patches arranged in the sheet width direction, and the scanner 46 reads patches other than the part of the patches read by the colorimeter 45, among the patches arranged in the sheet width direction.

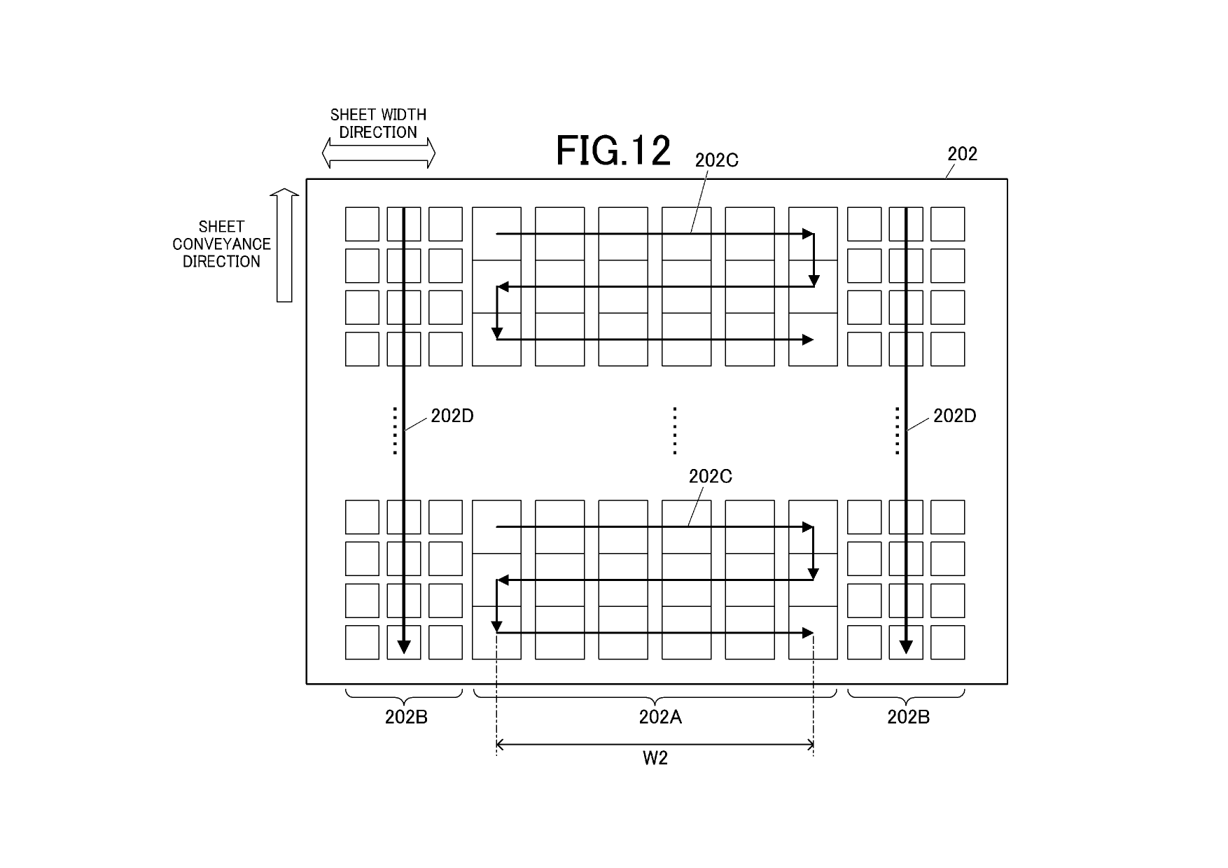

FIG. 12 shows an example of a chart 202 formed by the pattern B. For the pattern B, the CPU 51 of the color management apparatus 50 performs color management using both the data read by the colorimeter 45 and the data read by the scanner 46.

The CPU 41 of the reading apparatus 40 performs colorimetry while moving the colorimeter 45 in the sheet width direction so that the colorimeter 45 reads the patches in the area 202A of the chart 202. For example, the width W2 in FIG. 12 corresponds to the first length by which the colorimeter 45 moves in the sheet width direction in reading the pattern B. FIG. 12 illustrates the width W2 on the assumption that the colorimeter 45 reads the central position of each patch in the sheet width direction. The arrow 202C in FIG. 12 indicates the reading order of the patches by the colorimeter 45.

The CPU 41 obtains data of each patch read by the colorimeter 45. For each patch, the CPU 41 outputs an L*a*b* value, density value, wavelength characteristics, or the like.

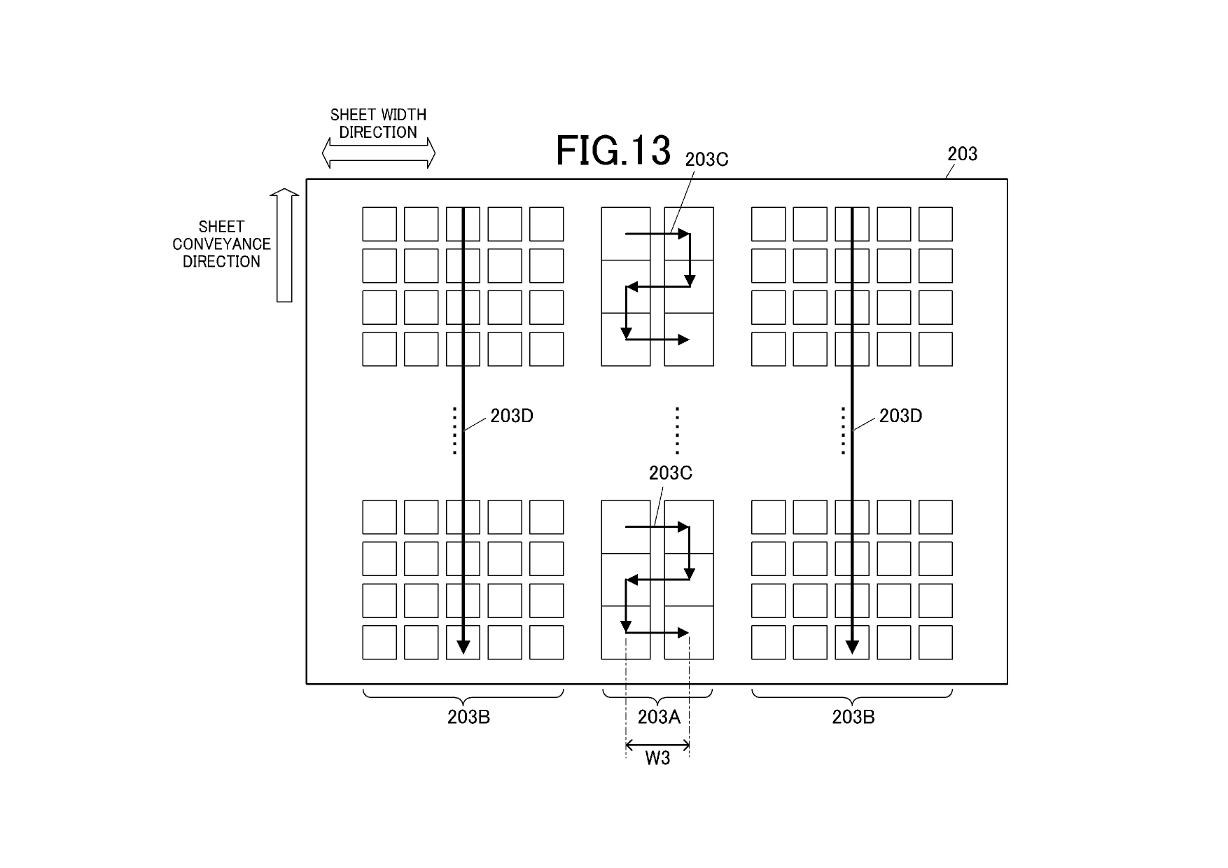

The CPU 41 causes the scanner 46 to read the patches in area 202B on the chart 202. The arrows 202D in FIG. 12 indicate the order in which the patches are read by the scanner 46. The scanner 46 simultaneously reads patches arranged in the sheet width direction. Therefore, in FIG. 12, the patches at the same position in the sheet conveyance direction in the area 202B are simultaneously read by the scanner 46 no matter whether the arrow 202D overlaps the patches. The same applies to arrows 203D, 204D, and 205D in FIG. 13 to FIG. 15.

The CPU 41 obtains the data of each patch read by the scanner 46. The CPU 41 obtains an RGB value of each patch as data of each patch from the scanner 46 and converts the RGB value into an L*a*b* value. CPU 41 outputs the L^{*} a^{*}b^{*} value for each patch as the read data by the scanner 46.

For the pattern B, the CPU 51 of the color management apparatus 50 obtains data of part of patches arranged in the sheet width direction read by the colorimeter 45 and obtains data of the other patches read by the scanner 46 other than the patches read by the colorimeter 45, among the patches arranged in the sheet width direction.

A pattern C is an example of the speed-prioritized pattern. In the pattern C, the scanner 46 reads part of the patches arranged in the sheet width direction, and the colorimeter 45 reads the patches other than the part of the patches read by the scanner 46, among the patches arranged in the sheet width direction.

FIG. 13 illustrates an example of a chart 203 for the pattern C. For the pattern C, the CPU 51 of the color management apparatus 50 performs color management using both the data read by the scanner 46 and the data read by the colorimeter 45.

The CPU 41 of the reading apparatus 40 performs colorimetry while moving the colorimeter 45 in the sheet width direction so that the colorimeter 45 reads the patches in the area 203A on the chart 203. For example, the width W3 in FIG. 13 corresponds to the “second length” by which the colorimeter 45 moves in the sheet width direction in reading the pattern C. FIG. 13 illustrates the width W3 on the assumption that the colorimeter 45 reads the central position of each patch in the sheet width direction. The width W3 by which the colorimeter 45 moves in the sheet width direction in reading the pattern C is narrower than the width W1 (see FIG. 11) by which the colorimeter 45 moves in the sheet width direction in reading the pattern A. The width W3 by which the colorimeter 45 moves in the sheet width direction in reading the pattern C is narrower than the width W2 (see FIG. 12) by which the colorimeter 45 moves in the sheet width direction in reading the pattern B. The arrow 203C in FIG. 13 indicates the reading order of the patches by the colorimeter 45.

The CPU 41 causes the scanner 46 to read the patches in the area 203B on the chart 203. The arrows 203D in FIG. 13 indicate the order in which the patches are read by the scanner 46.

For the pattern C, the CPU 51 of the color management apparatus 50 obtains data of part of patches arranged in the sheet width direction read by the scanner 46 and obtains data of the other patches read by the colorimeter 45 other than the patches read by the scanner 46, among the patches arranged in the sheet width direction.

A pattern D is an example of the speed-prioritized pattern. In the pattern D, the CPU 41 of the reading apparatus 40 corrects the data read by the scanner 46, based on the data read by the colorimeter 45.

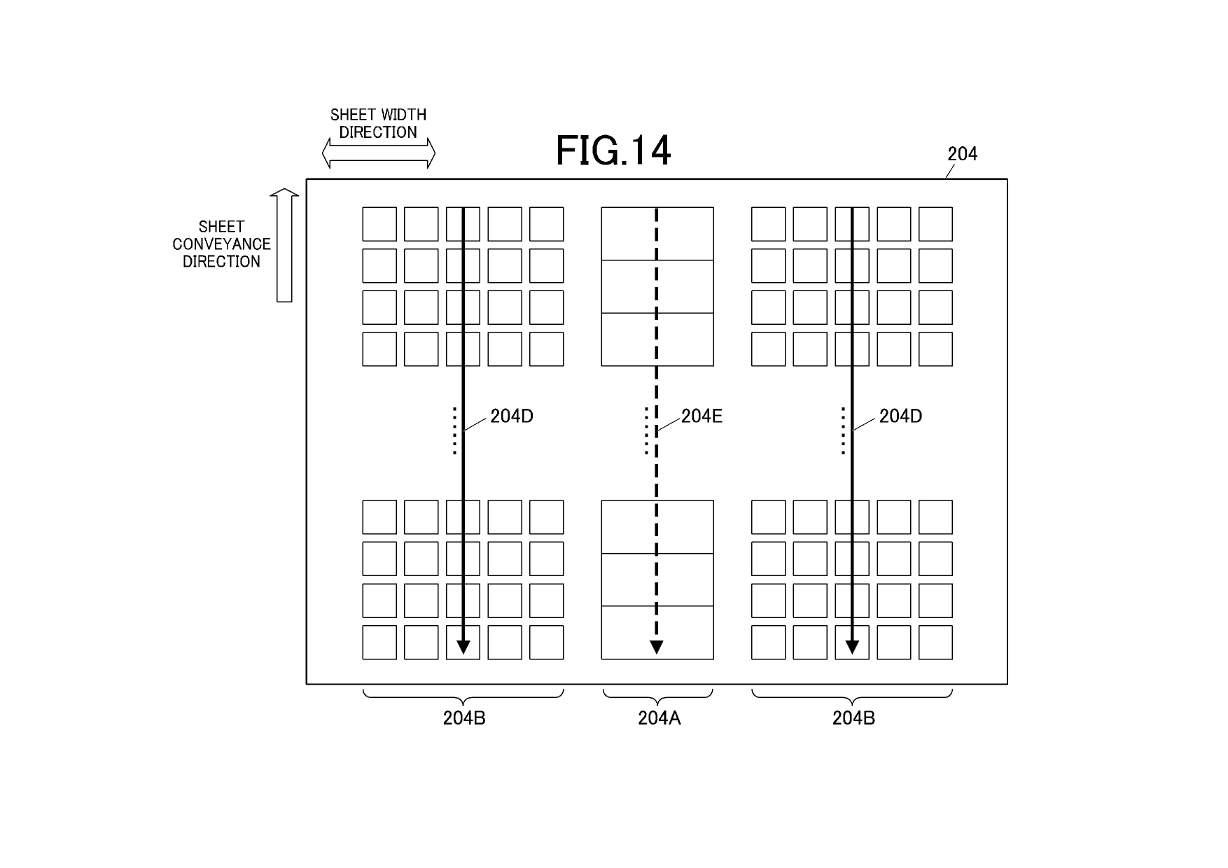

FIG. 14 illustrates an example of a chart 204 for the pattern D. For the pattern D, the CPU 51 of the color management apparatus 50 performs color management by using the read data of the scanner 46 that has been corrected based on the read data of the colorimeter 45.

The CPU 41 of the reading apparatus 40 performs colorimetry while keeping the colorimeter 45 stationary in the sheet width direction so that the colorimeter 45 reads the patches of the area 204A on the chart 204. The arrow 204E in FIG. 14 indicates the reading order of the patches by the colorimeter 45 to obtain data for correcting the scanner. In the area 204A, patches to be read by the colorimeter 45 are linearly arranged at the center in the sheet width direction of the chart 204. The patches read by the colorimeter 45 are used for correcting the scanner 46.

The CPU 41 causes the scanner 46 to read the patches in the areas 204B on the chart 204. The arrows 204D in FIG. 14 indicate the reading order of the patches by the scanner 46. In the chart 204, patches to be read by the scanner 46 are arranged on the right and left of patches to be read by the colorimeter 45.

Herein, the method of correcting the read data of the scanner 46 based on the read data of the colorimeter 45 will be described.

The patches read by the scanner 46 include a common-color patch that has the same color as a patch read by the colorimeter 45. The patches having the same color are formed with the same CMYK values (or CMYKW values) by the image forming section 36.

The CPU 41 of the reading apparatus 40 obtains a L^{*}a^{*}b* value (the actual L*a*b* value) of the common-color patch read by the colorimeter 45.

The CPU 41 converts the RGB value of the common-color patch read by the scanner 46 into a L^{*}a^{*}b* value using the scanner profile of the scanner 46 (color conversion) and obtains the L*a*b* value after the conversion as the estimated L*a*b* value.

Based on the difference between the actual L*a*b* value and the estimated L*a*b* value for each common-color patch, the CPU 41 corrects the scanner profile of the scanner 46 (calibration of the scanner 46). The correction of the scanner profile corresponds to the correction of the read data of the scanner 46 based on the read data of the colorimeter 45. The CPU 41 converts the values read by the scanner 46 into L*a*b* values using the corrected scanner profile and provides the converted values to the color management apparatus 50.

For the pattern D, the CPU 51 of the color management apparatus 50 obtains the data that has been read by the scanner 46 and corrected based on the data read by the colorimeter 45.

A pattern E is an example of the speed-prioritized pattern. In the pattern E, the colorimeter 45 is stationary in the sheet width direction, and the scanner 46 reads all the patches arranged in the sheet width direction. For another example, in the pattern E, part of the patches arranged in the sheet width direction may not be read by the scanner 46.

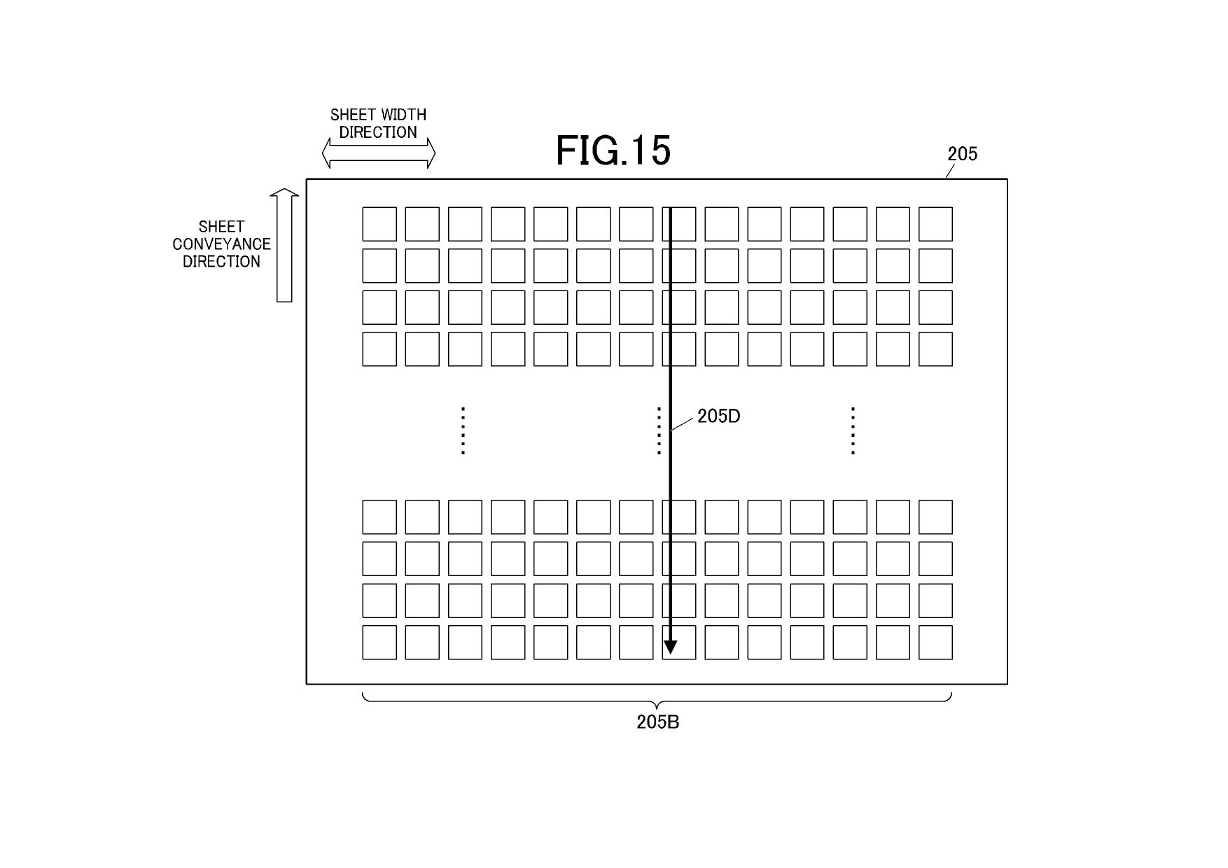

FIG. 15 shows an example of a chart 205 for the pattern E. For the pattern E, the CPU 51 of the color management apparatus 50 performs color management using only the data read by the scanner 46. The CPU 41 of the reading apparatus 40 causes the scanner 46 to read the patches in the area 205B on the chart 205. The arrow 205D in FIG. 15 indicates the reading order of the patches by the scanner 46.

For the pattern E, the number of patches read by the colorimeter 45 is zero. When the pattern E is used, the correction of the data read by the scanner 46 based on the data read by the colorimeter 45 is not performed.

The CPU 41 of the reading apparatus 40 obtains data of each patch read by the scanner 46. The CPU 41 obtains an RGB value of each patch as data of each patch from the scanner 46 and converts the RGB value into an L*a*b* value. The CPU 41 outputs the L^{*} a^{*}b^{*} value for each patch as the read data by the scanner 46.

For the pattern E, the CPU 51 of the color management apparatus 50 obtains data read by the scanner 46 but does not obtain data read by the colorimeter 45.

Compare the ratio between data read by the colorimeter 45 and data read by the scanner 46 among the patterns A to E. The pattern A has the highest ratio of data read by the colorimeter 45 among the patterns A to E. The pattern E has the highest ratio of data read by the scanner 46 among the patterns A to E. The patterns B, C, and D have different ratios between data read by the colorimeter 45 and data read by the scanner 46.

Further, the pattern A has the greatest number of patches read by the colorimeter 45 among the patterns A to E. The pattern E has the greatest number of patches read by the scanner 46 among the patterns A to E.

Note that, when the pattern D or the pattern E is used as the speed-prioritized pattern, the pattern C may be the accuracy-prioritized pattern. When the pattern A is used as the accuracy-prioritized pattern, the pattern B may be the speed-prioritized pattern.

In the charts 201 to 205 in FIG. 11 to FIG. 15, the size of patches read by the colorimeter 45 is greater than the size of patches read by the scanner 46. For another example, the patches read by the colorimeter 45 and the patches read by the scanner 46 may have the same size.

### Color Verification

The color verification will be described.

The CPU 51 of the color management apparatus 50 causes the image forming apparatus 30 (color management target) to print a color verification chart (a group of patches). The CPU 51 transmits an instruction to print the color verification chart to the printer controller 20 via the communication section 55. The instruction to print the color verification chart includes designation of the color verification chart, designation of the sheet, the screen, the number of copies, the profile to be applied in the color verification, and so forth. The CPU 21 of the printer controller 20 performs RIP processing and so forth on the chart. The CPU 21 transmits an instruction to print the color verification chart including the processed image data to the image forming apparatus 30 (color management target) via the communication section 25. In the image forming apparatus 30 (color management target), the CPU 31 controls the image forming section 36 to print the color verification chart.

Next, the CPU 51 of the color management apparatus 50 causes the reading apparatus 40 corresponding to the image forming apparatus 30 (color management target) to read the color verification chart. The CPU 51 transmits an instruction to read the color verification chart to the reading apparatus 40 via the communication section 55. In the reading apparatus 40, the CPU 41 controls the inline reading section 44 (the colorimeter 45 and the scanner 46) to read the color verification chart. The CPU 51 of the color management apparatus 50 obtains the read data from the reading apparatus 40 via the communication section 55 in the data obtaining mode corresponding to the color verification chart.

Next, the CPU 51 of the color management apparatus 50 compares the read data (colorimetric values) with the color verification standard and the allowable values to determine whether the colors printed by the image forming apparatus 30 satisfy the color verification standard. The CPU 51 causes the storage section 52 to store the determination result and causes the display part 53 to display the determination result.

### Color Profile Creation

Next, the color profile creation will be described.

The CPU 51 of the color management apparatus 50 causes the image forming apparatus 30 (color management target) to print a chart for creating a profile.

Next, the CPU 51 causes the reading apparatus 40 corresponding to the image forming apparatus 30 (color management target) to read the chart for creating a profile. The CPU 51 obtains the read data from the reading apparatus 40 via the communication section 55 in a data obtaining mode corresponding to the chart for creating a profile.

Printing and reading a chart is the same as the case of the color verification except that the target chart is different. Therefore, the detailed description thereof is omitted.

For each patch in the chart for creating a profile, an absolute value of the target color (e.g., L*a*b* values) is determined beforehand.

The CPU 51 creates a color profile, based on the difference between the read data (colorimetric value) and the target value for each patch. For example, the CPU 51 creates a printer profile and a device link profile. The CPU 51 transmits the created color profile to the image forming apparatus 30 (color management target) via the communication section 55.

In the image forming apparatus 30 (color management target), the CPU 31 stores the color profile in the storage section 32.

### Color Correction

Next, the color correction will be described. The color correction includes maximum density adjustment, in-plane unevenness adjustment, and gradation adjustment of the image forming apparatus 30.

The CPU 51 of the color management apparatus 50 performs the color correction specified by the user.

The CPU 51 causes the image forming apparatus 30 (color management target) to print a chart for color correction.

Next, the CPU 51 causes the reading apparatus 40 corresponding to the image forming apparatus 30 (color management target) to read the chart for color correction. The CPU 51 obtains the read data from the reading apparatus 40 via the communication section 55 in a data obtaining mode corresponding to the chart for color correction.

Printing and reading a chart is the same as the case of the color verification except that the target chart is different. Therefore, the detailed description thereof is omitted. In a case where the processing by the printer controller 20 is unnecessary in printing a chart, the instruction to print the chart may be directly transmitted from the color management apparatus 50 to the image forming apparatus 30 (color management target).

For example, in the maximum density adjustment, the CPU 51 causes the display part 53 to display the result of comparison between the measured maximum density and a predetermined target value for each color of CMYK (or CMYKW). The CPU 51 receives an adjusted value for the maximum density input by the user on the operation part 54. For another example, the CPU 51 may automatically calculate the adjustment value for the maximum density, based on the measurement result and the target value. The CPU 51 transmits the adjusted value for the maximum density to the image forming apparatus 30 (color management target) via the communication section 55.

In the image forming apparatus 30 (color management target), the CPU 31 stores the adjusted value for the maximum density in the storage section 32.

### Color Matching to Color Sample

Next, color matching to a color sample will be described.

The CPU 51 of the color management apparatus 50 creates (corrects) a target profile. The target profile is used when the colors of a printed material by the image forming apparatus 30 is matched to the colors of a color sample (target output material). The CPU 51 provides the created target profile to the image forming apparatus 30. The color sample is received (submitted) from a customer. The color sample is not data but an actually output material. The target profile indicates the correspondence between the document image data (CMYK values) input to the target printer that printed the color sample and the colorimetric values (L*a*b* values) obtained from the color sample.

The CPU 51 obtains the document image data (CMYK values) corresponding to the color sample. The document image data is image data from which the color sample was printed. The document image data is provided by the customer.

The CPU 51 obtains the read image data (RGB values) obtained by the document reading section 37 of the image forming apparatus 30 reading the color sample. The CPU 51 converts the RGB values of the read image data into L*a*b* values using a scanner profile of the document reading section 37, which is prepared beforehand. Note that the scanner profile of the document reading section 37 is assumed to be reliable. The CPU 51 may also obtain colorimetric values (L*a*b* values) of the color sample from a colorimeter connected to the color management apparatus 50.

The CPU 51 of the color management apparatus 50 creates a table in which the CMYK values and L*a*b* values of the corresponding positions in the document image data and the read image data are associated with each other. Based on this table, the CPU 51 creates a target profile for matching with the colors of the color sample.

By the combination of the target profile creation and the printer profile creation, the colors of the printed material by the image forming apparatus 30 can match with the colors of the color sample.

### Operation of Colorimeter

Next, the operation of the colorimeter 45 in the reading apparatus 40 will be supplementarily described. The colorimeter 45 needs to be moved in the sheet width direction to perform reading.

First, the spot colorimetry mode will be described. In the spot colorimetry mode, the colorimeter 45 performs colorimetry for each patch.

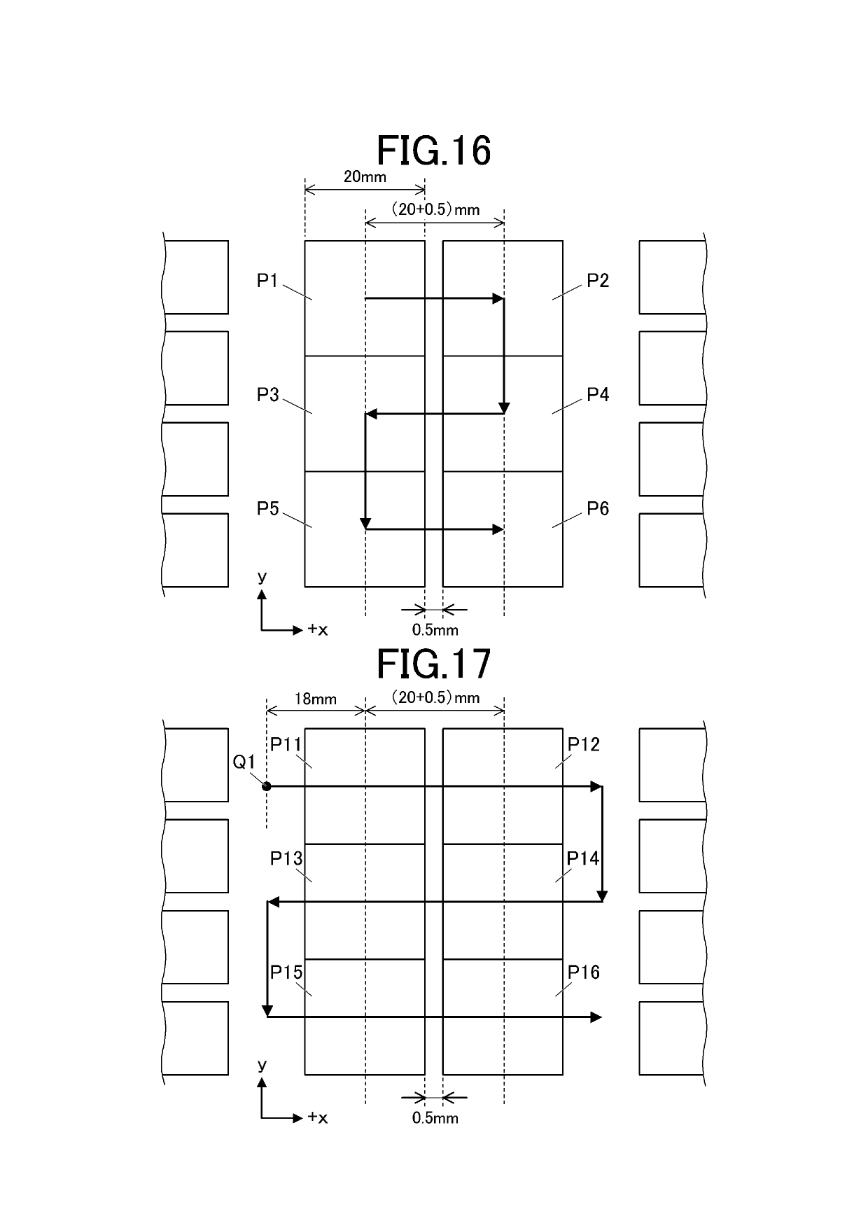

FIG. 16 is an enlarged view of part of patches to be read by the colorimeter 45 in the chart of the pattern C (see FIG. 13). In FIG. 16, the sheet width direction is the x-axis direction, and the sheet conveyance direction is the y-axis direction.

Herein, the size of each patch to be read by the colorimeter 45 is 20 mm × 20 mm. The gap between patches to be read by the colorimeter 45 is 0.5 mm in the sheet width direction.

The CPU 41 of the reading apparatus 40 moves the colorimeter 45 in sheet width direction to align the colorimeter 45 with the patches in the x-axis direction.

The CPU 41 aligns the colorimeter 45 with the patches in the y-axis direction by conveying the sheet.

Specifically, the CPU 41 moves the colorimeter 45 in the sheet width direction and stops the colorimeter 45 at the center position of the patch P1 in the x-axis direction. Next, the CPU 41 conveys and stops the sheet at a position where the center of the patch P1 in the y-axis direction corresponds to the colorimeter 45. Thus, the CPU 41 sets the colorimeter 45 at the colorimetry start position of the patch P1.

After the colorimetry starts, the following is performed.

(1) The CPU 41 causes the colorimeter 45 to perform colorimetry on the patch P1 and obtains data.

(2) The CPU 41 moves the colorimeter 45 in the +x direction by 20.5 mm, which is the total of the lateral width of the patch 20 mm and the gap 0.5 mm.

(3) The CPU 41 causes the colorimeter 45 to perform colorimetry on the patch P2 and obtains data.

(4) The CPU 41 conveys the sheet by 20 mm, which is the longitudinal width of the patch, in the y-axis direction and stops the sheet.

(5) The CPU 41 causes the colorimeter 45 to perform colorimetry on the patch P4 and obtains data.

(6) The CPU 41 moves the colorimeter 45 in the -x direction by 20.5 mm, which is the total of the lateral width of the patch 20 mm and the gap 0.5 mm.

(7) The CPU 41 causes the colorimeter 45 to perform colorimetry on the patch P3 and obtains data.

(8) The CPU 41 conveys the sheet by 20 mm, which is the longitudinal width of the patch, in the y-axis direction and stops the sheet.

(9) The CPU 41 causes the colorimeter 45 to perform colorimetry on the patch P5 and obtains data.

Thereafter, the CPU 41 repeats the same processing and controls colorimetry by the colorimeter 45.

FIG. 16 shows an example case where two patches to be read by the colorimeter 45 are arranged in the sheet width direction. The same applies to a case where three or more patches are arranged in the sheet width direction.

Next, the line colorimetry mode will be described. In the line colorimetry mode, the colorimeter 45 performs colorimetry line by line. In performing colorimetry line by line, if a color difference between measured patches is equal to or greater than a predetermined value, the CPU 41 determines that the patches are different patches, for example. The CPU 41 also determines that the patches are different by recognizing a gap (border line) between the patches. The gap is defined for each colorimeter 45. For example, the gap is white or black line having a width of 0.5 mm.

FIG. 17 is an enlarged view of part of patches to be read by the colorimeter 45 in the chart 203 of the pattern C. In FIG. 17, the sheet width direction is the x-axis direction, and the sheet conveyance direction is the y-axis direction.

Herein, the size of each patch to be read by the colorimeter 45 is 20 mm × 20 mm. The gap between patches to be read by the colorimeter 45 is 0.5 mm in the sheet width direction.

In the line colorimetry mode, the CPU 41 starts colorimetry with the colorimeter 45 from the base sheet and moves the colorimeter 45 in the sheet width direction. The CPU 41 causes the colorimeter 45 to pass over the patches arranged in the x-axis direction and ends the colorimetry on the base sheet, thereby obtaining colorimetry data of one line. The base sheet is a portion of the sheet itself on which no patch is printed. The colorimetry data of one line is time-series data of colorimetric values. Specifically, the colorimetry target by the colorimeter 45 changes from the base sheet at the starting side, a patch, a gap, a patch, a gap, … to the base sheet at the ending side. The CPU 41 removes colorimetric values corresponding to the base sheet and the gaps, thereby obtaining colorimetric values of the respective patches.

The CPU 41 causes the colorimeter 45 to wait at the position of the base sheet. Specifically, the CPU 41 moves the colorimeter 45 in the sheet width direction and sets the colorimeter 45 at a position 18 mm away in the -x direction from the x-axis center position of the patch P11. Herein, 18 mm is the total of the half-width of one patch and 8 mm.

In the y-axis direction, the CPU 41 conveys and stops the sheet at a position where the center of the patch P11 in the y-axis direction corresponds to the colorimeter 45. Thus, the CPU 41 sets the colorimeter 45 at the colorimetry start position Q1.

The moving distance of the colorimeter 45 in the sheet width direction per line is 56.5 mm (18 mm + 20 mm + 0.5 mm + 18 mm) in consideration of the gap and the base sheet before and after colorimetry.

When colorimetry starts from the base sheet, the processing is as follows.

(1) The CPU 41 obtains colorimetry data of one line by moving the colorimeter 45 by 56. 5 mm in the +x direction.

(2) The CPU 41 obtains data of the patches P11 and P12 from the colorimetry data of one line.

(3) The CPU 41 conveys the sheet by 20 mm (longitudinal width of one patch) in the y-axis direction and stops the sheet.

(4) The CPU 41 obtains colorimetry data of one line by moving the colorimeter 45 by 56.5 mm in the -x direction.

(5) The CPU 41 obtains data of the patches P14 and P13 from the colorimetry data of one line.

(6) The CPU 41 conveys the sheet by 20 mm (longitudinal width of one patch) in the y-axis direction and stops the sheet.

(7) The CPU 41 obtains colorimetry data of one line by moving the colorimeter 45 by 56.5 mm in the +x direction.

(8) The CPU 41 obtains data of the patches P15 and P16 from the colorimetry data of one row.

Thereafter, the CPU 41 repeats the same processing and controls colorimetry by the colorimeter 45.

If the number of patches from which data (colorimetric values) was obtained in one line is less than the number of patches at the time of determining the reading operation, the CPU 41 may reversely move the colorimeter 45 for the same line to reobtain patch data.

For example, if only one patch is obtained in the above step (5), the CPU 41 performs the following processing without performing the next sheet conveyance step (6).

The CPU 41 obtains colorimetry data of one line by moving the colorimeter 45 by 56.5 mm in the +x direction.

The CPU 41 obtains data of the patches P13 and P14 from the colorimetry data of one line.

Thereafter, the +x and -x directions with respect to the movement of the colorimeter 45 in the sheet width direction are reversed.

FIG. 17 shows an example case where two patches to be read by the colorimeter 45 are arranged in the sheet width direction. The same applies to a case where three or more patches are arranged in the sheet width direction.

The line colorimetry by the colorimeter 45 can be used if two or more patches are arranged in the sheet width direction. Both the spot colorimetry and line colorimetry can be used if there is a gap between patches in a chart. In the following description, the colorimetry by the colorimeter 45 may be either the spot colorimetry or the line colorimetry. The CPU 41 of the reading apparatus 40 may automatically determine which colorimetry method is faster and select the colorimetry method with a shorter processing time. For example, it is desirable that the CPU 41 select the line colorimetry for the pattern A.

Next, the operation of the color management system 100 according to a first embodiment will be described.

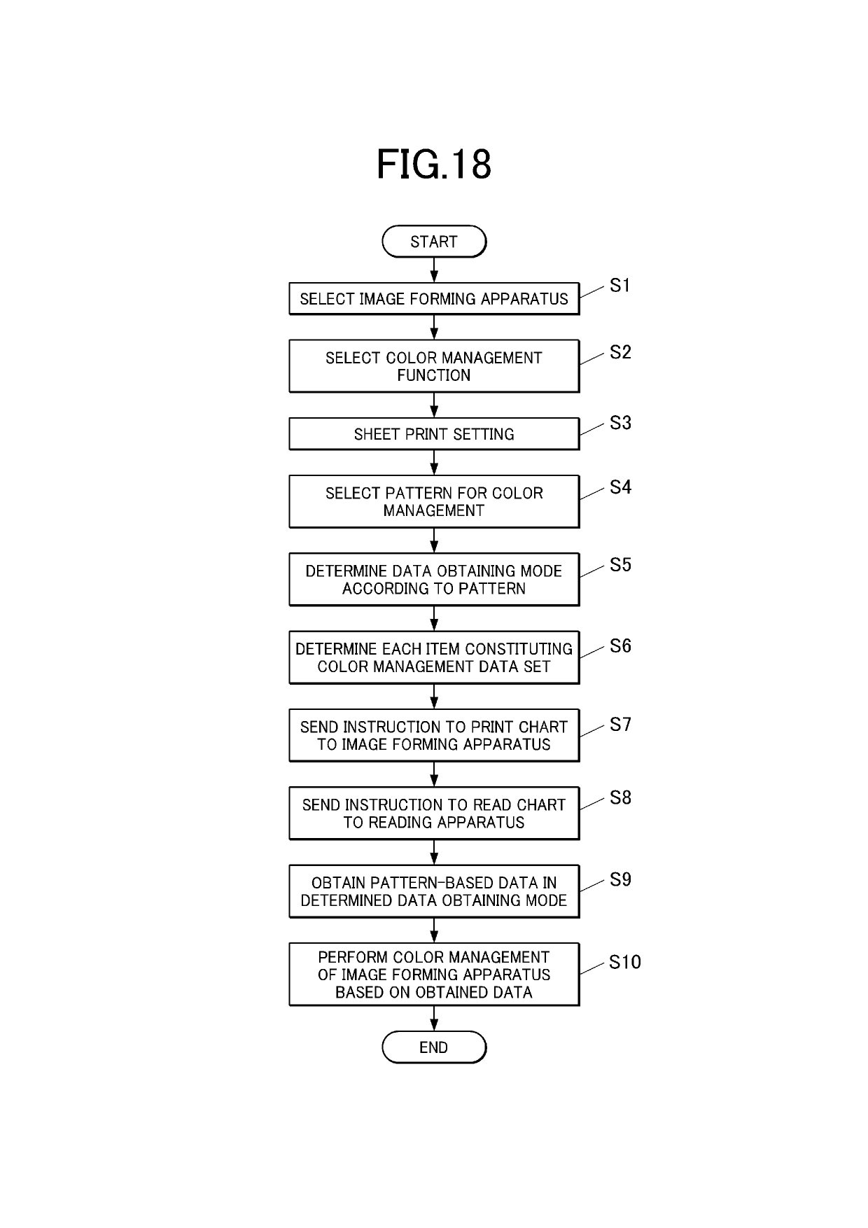

FIG. 18 is a flowchart of a first color management process to be executed by the color management apparatus 50.

First, the CPU 51 receives selection of an image forming apparatus 30 as a color management target (step S1). The user selects an image forming apparatus 30 by operating the operation part 54.

Next, the CPU 51 receives selection of a color management function (step S2). The user selects a color management function by operating the operation part 54. One color management function or a combination of color management functions are selected from color verification, color profile creation, and color correction, for example.

Next, the CPU 51 receives sheet print setting (step S3).

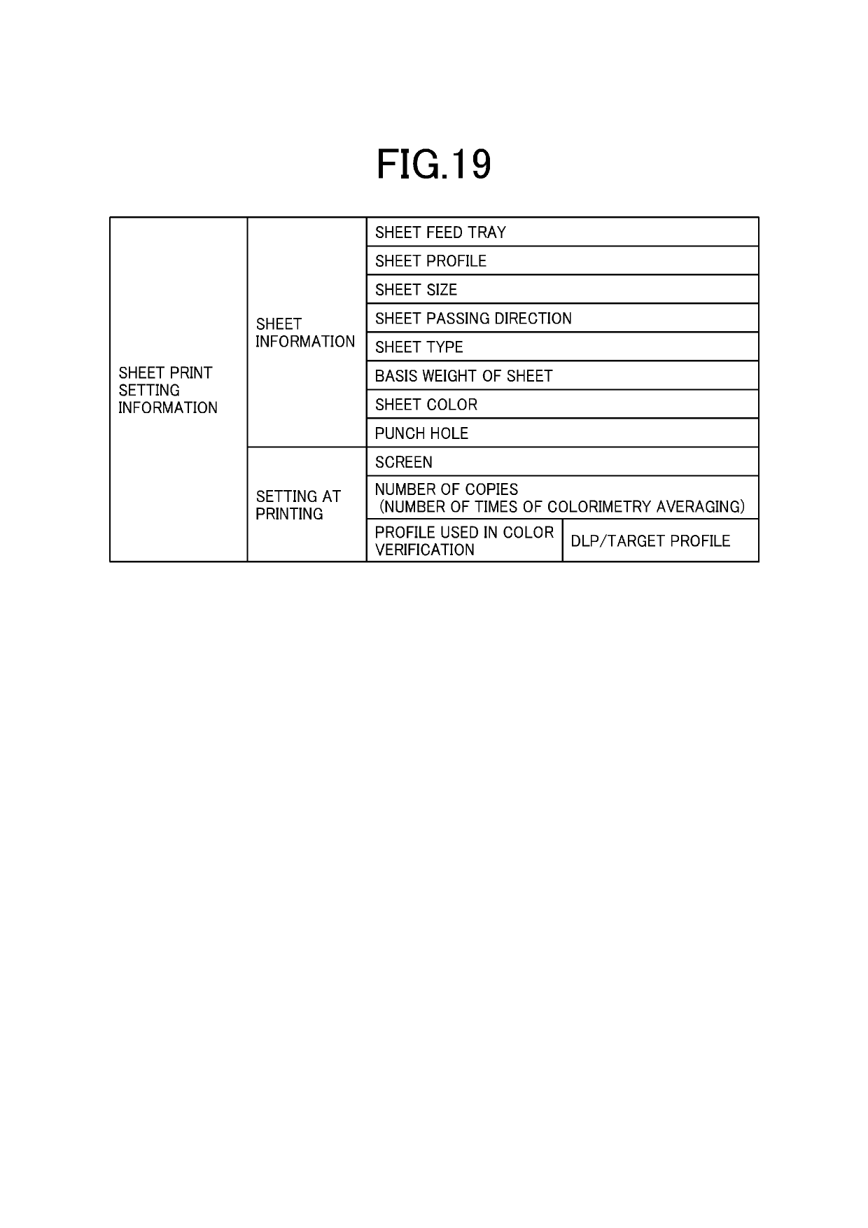

FIG. 19 illustrates a data structure of sheet print setting information to be set in step S3.

The "sheet print setting information" includes sheet information of a sheet subjected to the color management and settings at printing.

The "sheet information" includes a sheet feed tray, sheet profile, sheet size, sheet passing direction, sheet type, sheet basis weight, sheet color, and punch hole.

The "setting at printing" includes a screen, the number of copies (the number of times of colorimetry averaging), and a profile to be used in color verification (DLP/target profile).

The user sets the items regarding the sheet information of the sheet subjected to the color management and settings at printing by operating the operation part 54.

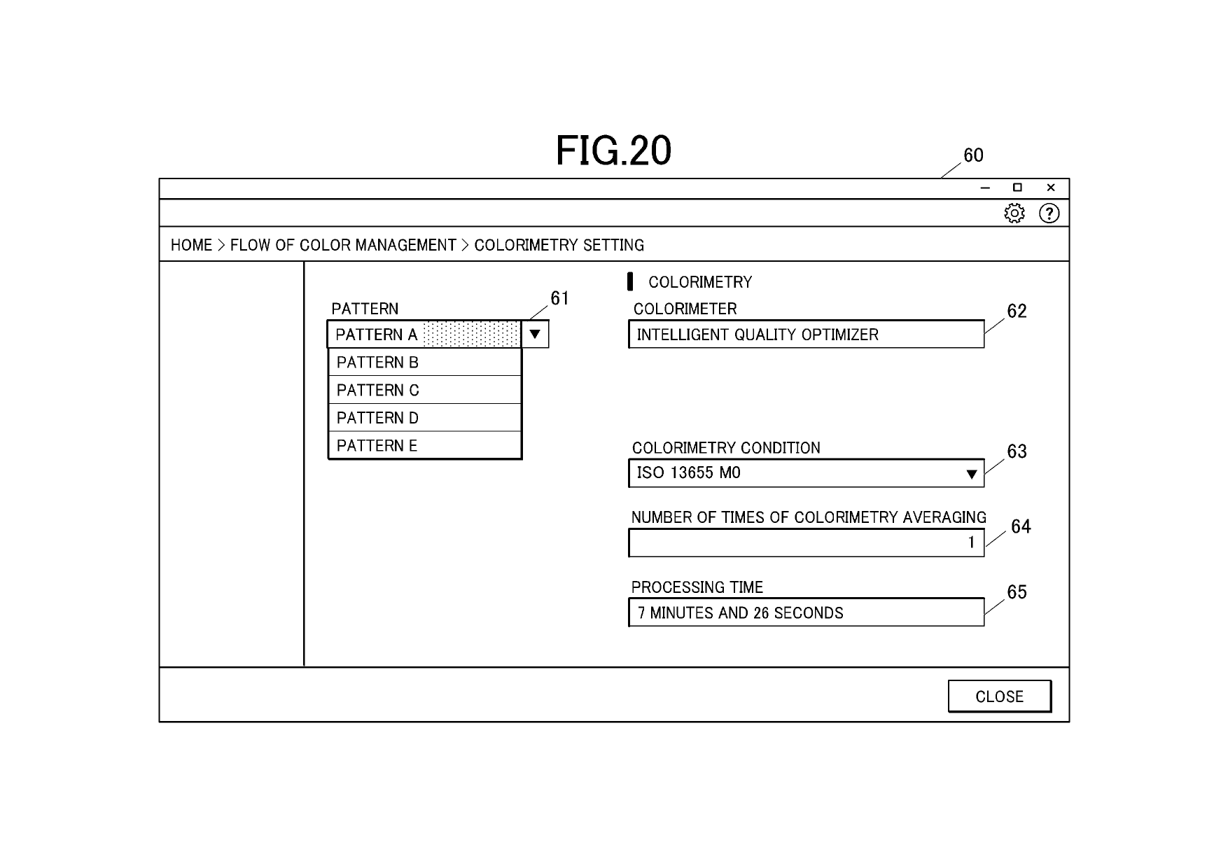

Next, the CPU 51 receives selection of a pattern (chart) to be used for color management (step S4). The CPU 51 displays a colorimetry setting screen 60 illustrated in FIG. 20 on the display part 53. The colorimetry setting screen 60 includes a pattern selection field 61, a colorimeter display field 62, a colorimetry condition selection field 63, a field 64 for inputting the number of times of colorimetry averaging, and a processing time display field 65.

The pattern selection field 61 is for selecting a pattern from patterns (charts) registered beforehand. The options of patterns A to E are displayed as a pull-down menu so that the user can select any one of the patterns.

In the colorimeter display field 62, a colorimeter corresponding to the selected pattern in the pattern selection field 61 is displayed.

The colorimetry condition selection field 63 is for selecting colorimetry conditions.

The field 64 is for inputting the number of times of colorimetry averaging.

The processing time display field 65 shows the processing time related to color management corresponding to the selected pattern in the pattern selection field 61.

The user selects a pattern to be used for color management in the pattern selection field 61 of the colorimetry setting screen 60 by operating the operation part 54.

Next, the CPU 51 determines the data obtaining mode corresponding to the selected pattern (step S5). For example, when the pattern A is selected, the CPU 51 is going to obtain data from the reading apparatus 40 in a data obtaining mode based on the pattern A.

Next, the CPU 51 receives settings of the items constituting the color management dataset (step S6). For example, the user sets the items in the colorimetry condition selection field 63, the field 64, and so forth on the colorimetry setting screen 60 by operating the operation part 54. Although not illustrated in FIG. 20, the items included in the color management dataset table T2 (see FIG. 10) can be set.

Next, the CPU 51 sends an instruction to print the chart to the printer controller 20 or the image forming apparatus 30 via the communication section 55 (step S7). Specifically, the CPU 51 sends the color management dataset, sheet print setting information, and chart information to the image forming apparatus 30 as the chart-related data. The color management dataset is the information set in step S6. The sheet print setting information is the information set in step S3. The chart information indicates a chart corresponding to the pattern selected in step S4. The chart information is image data, CGATS data, or the like.

The CPU 31 of the image forming apparatus 30 controls the image forming section 36 to print the chart. Specifically, the CPU 31 causes the image forming section 36 to print the chart in accordance with the sheet print setting information. The CPU 31 conveys the printed sheet (chart) to the reading apparatus 40. Based on the colorimetry settings included in the color management dataset and the chart information, the CPU 31 distinguishes between the area to be read by the colorimeter 45 and the area to be read by the scanner 46 in the chart, and determines the number of patches in each area. The CPU 31 determines the reading operations of the colorimeter 45 and the scanner 46 of the reading apparatus 40, based on the area to be read by the colorimeter 45, the area to be read by the scanner 46, and the number of patches in each area. The CPU 31 transmits information indicating the reading operations to the reading apparatus 40 via the communication section 35.

Next, the CPU 51 of the color management apparatus 50 sends an instruction to read the chart to the reading apparatus 40 via the communication section 55 (step S8).

The CPU 41 of the reading apparatus 40 controls the inline reading section 44 to read the chart. The CPU 41 controls reading of the chart by the colorimeter 45 and the scanner 46, based on the instruction to read the chart from the color management apparatus 50 and the information indicating the reading operations from the image forming apparatus 30.

The CPU 51 of the color management apparatus 50 obtains the read data from the reading apparatus 40 via the communication section 55 in the determined data obtaining mode (step S9).

The CPU 51 performs color management of the image forming apparatus 30, based on the obtained data (step S10). The CPU 51 performs color management of the image forming apparatus 30, based on the color management dataset determined in step S6. Details of the color management are as described above.

Thus, the first color management process ends.

In the colorimetry setting screen 60 in FIG. 20, the pattern selection field 61 receives selection of a pattern (chart). For another example, the CPU 51 may receive selection of the data obtaining mode at the color management apparatus 50 and automatically select a pattern corresponding to the data obtaining mode.

According to the first embodiment, the CPU 51 of the color management apparatus 50 switches between the mode in which the data based on the accuracy-prioritized pattern (first pattern) is obtained and the mode in which the data based on the speed-prioritized pattern (second pattern) is obtained. Therefore, the CPU 51 can perform color management, based on the balance between a required quality and delivery date.

With recent developments of image formation technologies, various image formation processes have emerged, such as printing with a special-color toner, decorated printing, and printing on special sheets. For example, when images are formed with CMYK toner on white toner or when gray images are formed with only CMY toner without K toner (black toner), accuracy of colorimetric values by the scanner 46 may decrease. The present disclosure is particularly effective in such situations.

For example, in the data obtaining mode based on the pattern A (see FIG. 11), the CPU 51 uses only the data read by the colorimeter 45 to perform color management. Therefore, the CPU 51 can accurately perform color management.

In the data obtaining mode based on the pattern E (see FIG. 15), the CPU 51 uses only the data read by the scanner 46 to perform color management. Therefore, the CPU 51 can shorten time for reading the chart and quickly perform color management.

In the data obtaining mode based on the pattern B (see FIG. 12) and the data obtaining mode based on the pattern C (see FIG. 13), the CPU 51 uses both the data read by the colorimeter 45 and the data read by the scanner 46 to perform color management. Therefore, the CPU 51 can perform color management while balancing accuracy and speed.

In the data obtaining mode based on the pattern D (see FIG. 14), the CPU 51 uses the data read by the scanner 46 and corrected based on the data read by the colorimeter 45 to perform color management. By using the data read by the scanner 46 and corrected based on the data read by the colorimeter 45, the CPU 51 can maintain accuracy of color management.

When the reading apparatus 40 reads the chart corresponding to the pattern D or E, the colorimeter 45 does not move in the sheet width direction. Therefore, time required for reading the chart can be reduced.

In the first embodiment, the CPU 31 of the image forming apparatus 30 determines the area to be read by the colorimeter 45, the area to be read by the scanner 46, and the number of patches in each area in the chart. For another example, the CPU 51 of the color management apparatus 50 may send, to the reading apparatus 40 via the communication section 55, information on the area to be read by the colorimeter 45, the area to be read by the scanner 46, and the number of patches in each area in the chart.

### Second Embodiment

Next, a second embodiment of the present disclosure will be described.

The configuration of the color management system in the second embodiment is the same as that of the color management system 100 in the first embodiment. The same components as the first embodiment are denoted by the same reference signs, and description thereof is omitted. Hereinafter, characteristic aspects and processing of the second embodiment will be described.

The CPU 51 of the color management apparatus 50 performs color management, based on a color management dataset.

The CPU 51 receives setting of a color management dataset.

The CPU 51 obtains mode setting (data obtaining mode) corresponding to the set color management dataset.

The CPU 51 obtains the data in the mode indicated by the obtained mode setting.

Specifically, the CPU 51 obtains the data in the mode indicated by the mode setting included in the set color management dataset.

Next, the operation of the color management system 100 in the second embodiment will be described.

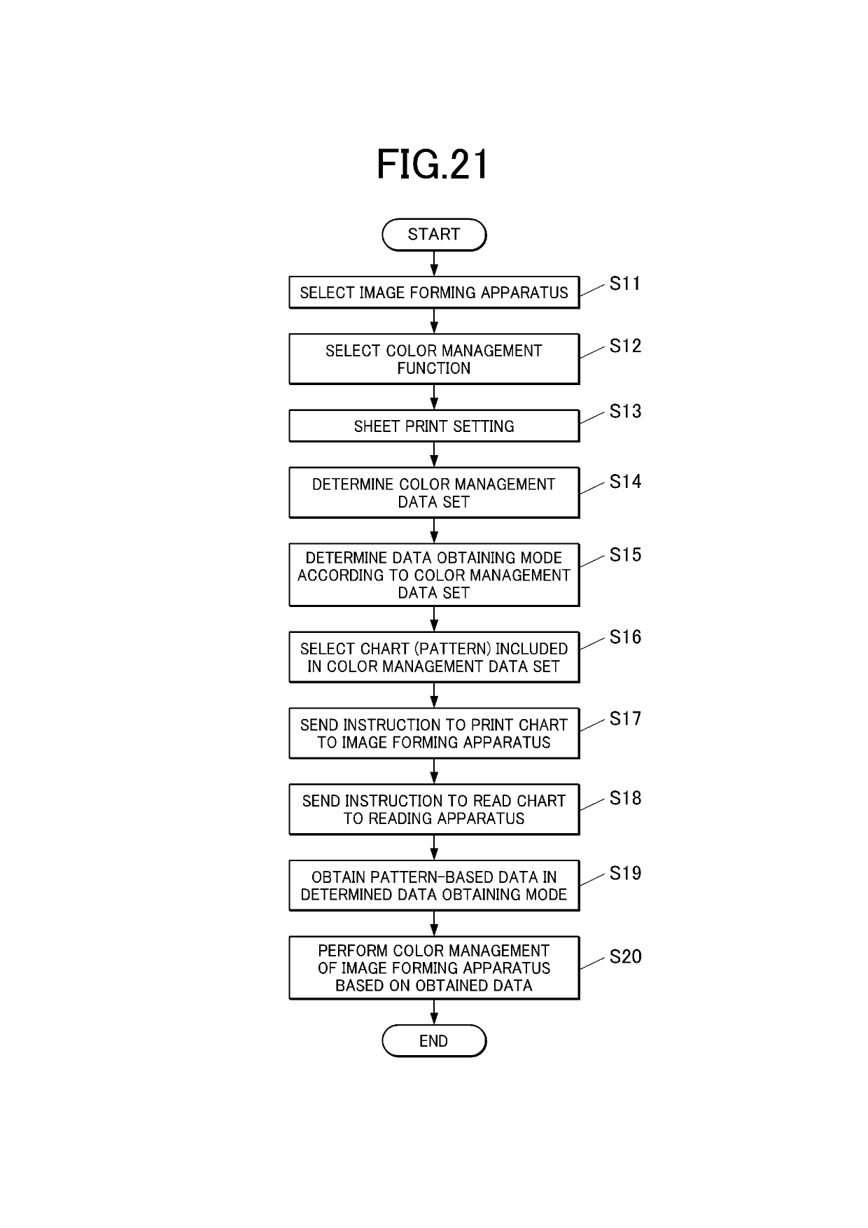

FIG. 21 is a flowchart of a second color management process to be executed by the color management apparatus 50.

Steps S11 to S13 are the same as Step S1 to S3 in the first color management process (see FIG. 18). Therefore, description thereof is omitted.

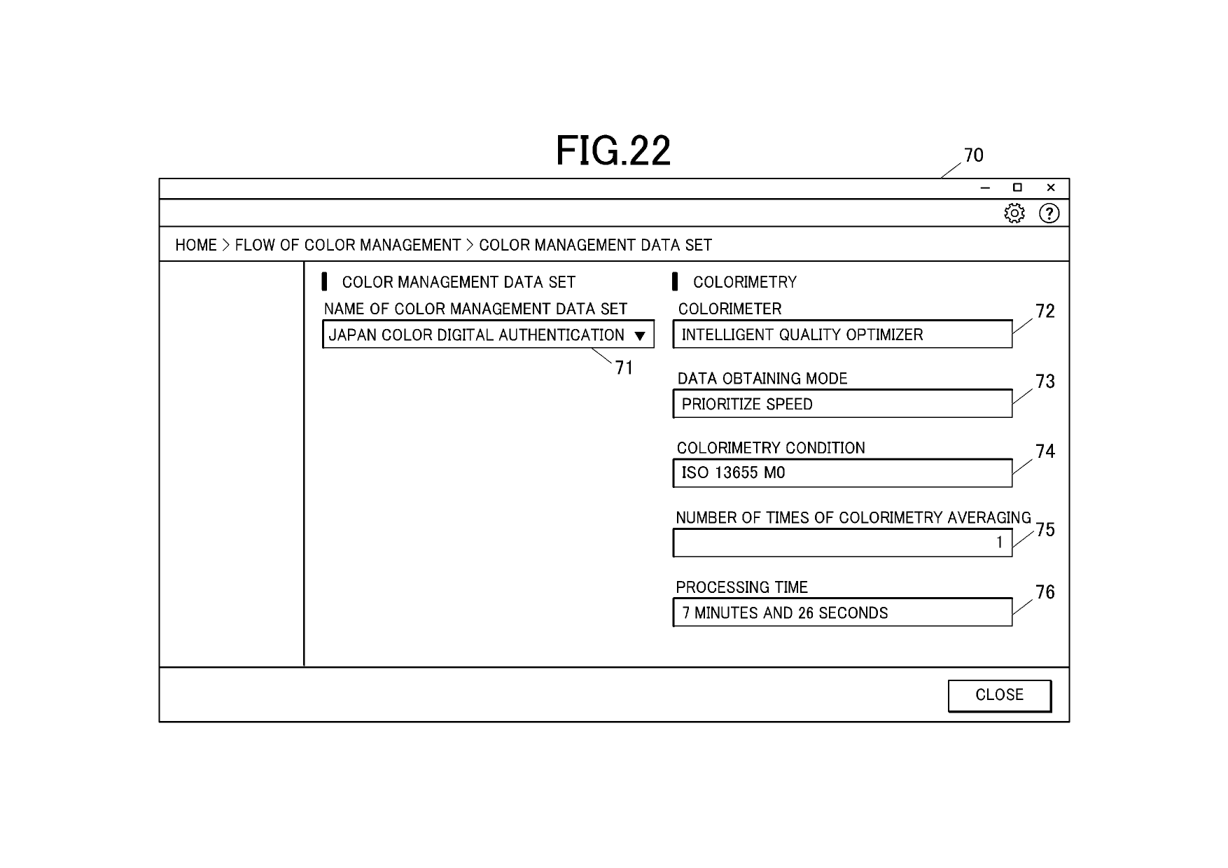

Next, the CPU 51 receives setting of a color management dataset (step S14).The CPU 51 displays a color management dataset selection screen 70 as illustrated in FIG. 22 on the display part 53. The color management dataset selection screen 70 includes a color management dataset selection field 71, a colorimeter display field 72, a data obtaining mode display field 73, a colorimetry condition display field 74, a field 75 for displaying the number of times of colorimetry averaging, and a processing time display field 76.

The color management dataset selection field 71 is an area for selecting a color management dataset from color management datasets (target configurations) registered in the color management dataset table T2 (see FIG. 10).

The colorimeter display field 72, the data obtaining mode display field 73, the colorimetry condition display field 74, and the field 75 for displaying the number of times of colorimetry averaging each show setting contents included in the color management dataset selected in the color management dataset selection field 71.

The processing time display field 76 shows the processing time related to color management corresponding to the data obtaining mode shown in the data obtaining mode display field 73.

In the color management dataset selection field 71 of the color management dataset selection screen 70, the user sets any one of the color management datasets by operating the operation part 54.

The CPU 51 determines the data obtaining mode corresponding to the set color management dataset (step S15). Specifically, the CPU 51 refers to the color management dataset table T2 and obtains setting of the data obtaining mode included in the set color management dataset.

Next, the CPU 51 selects a chart (pattern) included in the set color management dataset. Specifically, the CPU 51 refers to the color management dataset table T2 and obtains the profiling chart and the color verification wedge included in the set color management dataset.

Next, the CPU 51 sends an instruction to print the chart to the printer controller 20 or the image forming apparatus 30 via the communication section 55 (step S17). Specifically, the CPU 51 sends the color management dataset, sheet print setting information, and chart information to the image forming apparatus 30 as the chart-related data. The color management dataset is the information set in step S14. The sheet print setting information is the information set in step S13. The chart information indicates the chart selected in step S16. The chart information is image data, CGATS data, or the like.

The image forming apparatus 30 prints the chart in the same way as in the first color management process.

Steps S18 to S20 are the same as steps S8 to S10 in the first color management process. Therefore, description thereof is omitted.

Thus, the second color management process ends.

According to the second embodiment, the CPU 51 of the color management apparatus 50 can perform color management while balancing a required quality and delivery date, as with the first embodiment.

Further, the CPU 51 receives setting of a color management dataset and obtains setting of a mode corresponding to the set color management dataset. Specifically, the CPU 51 obtains setting of the data obtaining mode included in the set color management dataset. Therefore, the CPU 51 can obtain setting of the data obtaining mode corresponding to the setting of the color management dataset without requiring the operator to make a high-level determination.

In the second embodiment, the setting of the data obtaining mode is included in the color management dataset. However, the setting of the data obtaining mode may not be included in the color management dataset. The setting of the data obtaining mode may be managed as data different from the color management dataset. It is sufficient that the CPU 51 of the color management apparatus 50 can identify the setting of the data obtaining mode corresponding to the color management dataset when obtaining the setting of the data obtaining mode.

### Third Embodiment

Next, a third embodiment of the present disclosure will be described.

The configuration of the color management system in the third embodiment is the same as that of the color management system 100 in the first embodiment. The same components as the first embodiment are denoted by the same reference signs, and description thereof is omitted. Hereinafter, characteristic configurations and processing of the third embodiment will be described.

The CPU 51 of the color management apparatus 50 switches modes between a mode of obtaining the data based on the accuracy-prioritized pattern (first pattern) and a mode of obtaining the data based on the speed-prioritized pattern (second pattern) in one process related to color management. For example, in one process, such as color verification, color profile creation, and color correction, the CPU 51 switches the data obtaining modes.

Based on the ratio determined based on the setting of the user, the CPU 51 switches modes between the mode of obtaining data based on the accuracy-prioritized pattern and the mode of obtaining data based on the speed-prioritized pattern.

Regarding a first area on a sheet, the CPU 51 obtains data based on the accuracy-prioritized pattern. Regarding a second are different from the first area on the sheet, the CPU 51 obtains data based on the speed-prioritized pattern. That is, a color management chart printed on one sheet by the image forming apparatus 30 includes an area in which the accuracy-prioritized pattern is printed and an area in which the speed-prioritized pattern is printed.

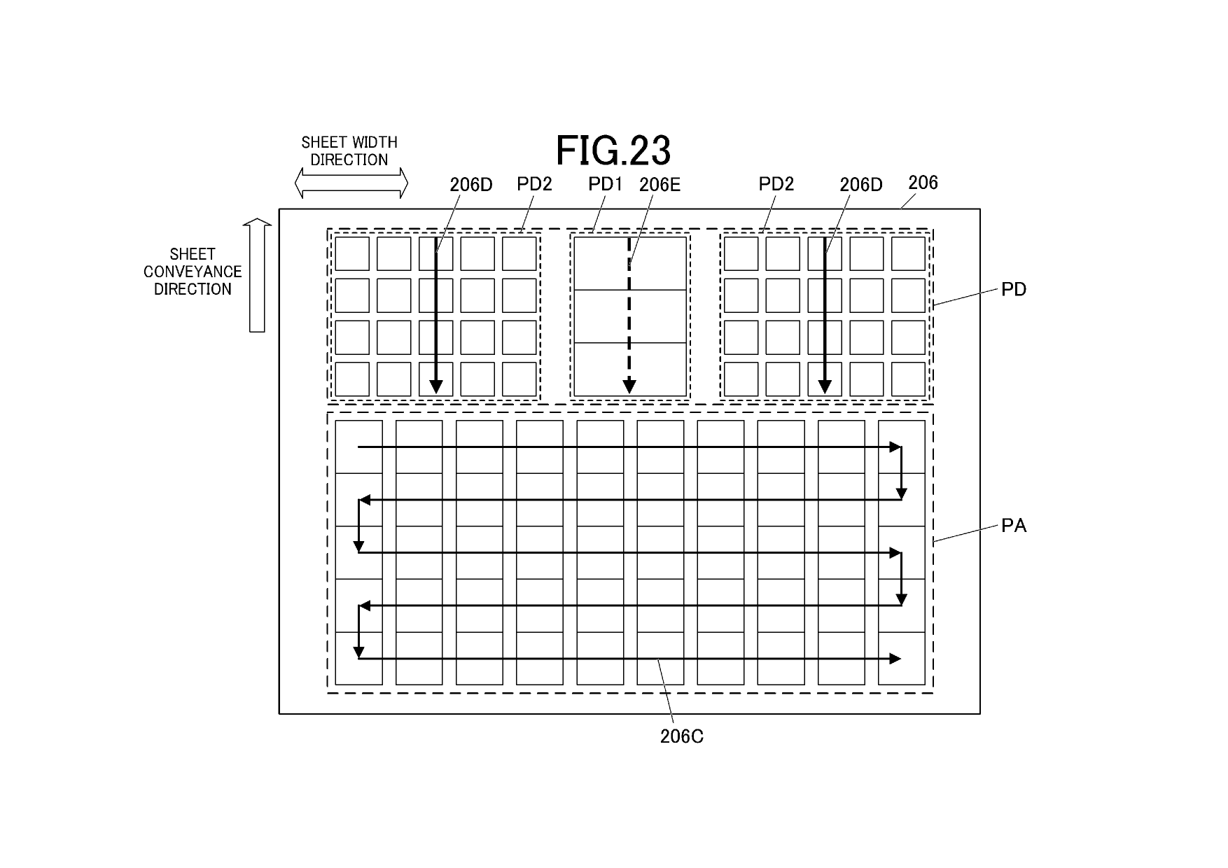

FIG. 23 illustrates an example of a chart 206 that includes the accuracy-prioritized pattern and the speed-prioritized pattern the same page. The chart 206 includes an area PA in which the pattern A (refer to FIG. 11) is printed and an area PD in which the pattern D (refer to FIG. 14) is printed. The area PD includes an area PD1 to be read by the colorimeter 45 and an area PD2 to be read by the scanner 46.

The CPU 41 of the reading apparatus 40 performs colorimetry while keeping the colorimeter 45 stationary in the sheet width direction so that the colorimeter 45 reads the patches of the area PD1 on the chart 206. An arrow 206E in FIG. 23 indicates the reading order of patches by the colorimeter 45 to obtain data for scanner correction. The CPU 41 causes the scanner 46 to read the patches in the area PD2 on the chart 206. Arrows 206D in FIG. 23 indicate the reading order of patches by the scanner 46. The scanner 46 simultaneously reads patches at the same position in the sheet conveyance direction in the area PD2 no matter whether the arrows 206D overlap with the patches in FIG. 23. For the area PD of the chart 206, the CPU 51 of the color management apparatus 50 obtains data based on the pattern D from the reading apparatus 40. Specifically, the CPU 51 obtains data that has been read by the scanner 46 and corrected based on the data read by the colorimeter 45.

The CPU 41 of the reading apparatus 40 performs colorimetry while moving the colorimeter 45 in the sheet width direction so that the colorimeter 45 reads the patches in the area PA on the chart 206. The arrow 206C in FIG. 23 indicates the reading order of patches by the colorimeter 45. For the area PA of the chart 206, the CPU 51 of the color management apparatus 50 obtains data based on the pattern A from the reading apparatus 40.

In the example of FIG. 23, the CPU 51 of the color management apparatus 50 switches data obtaining modes within a single sheet.

The image forming apparatus 30 (image forming engine) may print the patches on multiple sheets.

For a first sheet among the multiple sheets, the CPU 51 of the color management apparatus 50 obtains data based on the accuracy-prioritized pattern. For a second sheet different from the first sheet among the sheets, the CPU 51 obtains data based on the speed-prioritized pattern.

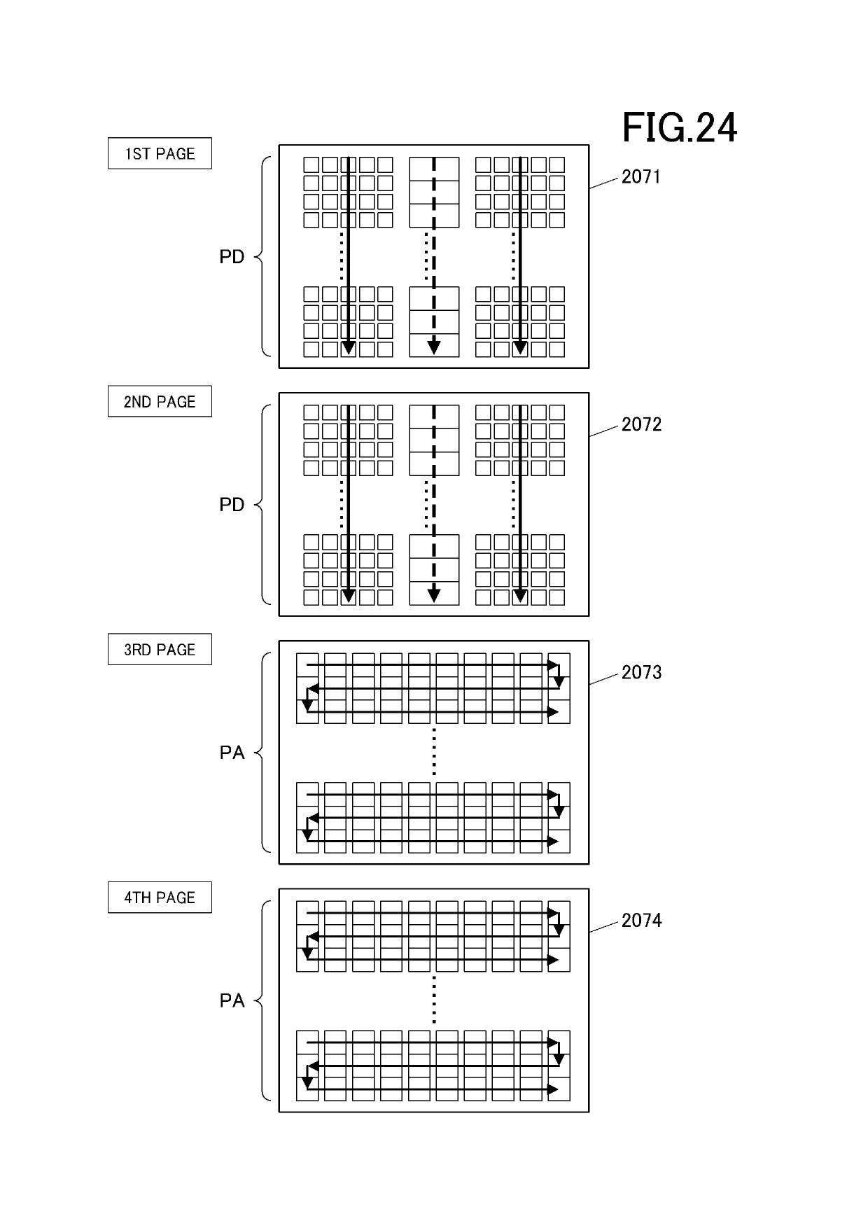

FIG. 24 illustrates an example of charts 2071 to 2074 that consist of multiple pages and that include the accuracy-prioritized pattern and a speed-prioritized pattern. The chart 2071 on the first page and the chart 2072 on the second page each include an area PD on which the pattern D (see FIG. 14) is printed. The chart 2073 on the third page and the chart 2074 on the fourth page include an area PA on which the pattern A (see FIG. 11) is printed.

The reading apparatus 40 reads the areas PD and PA the same way as reading the chart 206 (see FIG. 23).

For the charts 2071 and 2072 among the multiple sheets, the CPU 51 obtains data based on the pattern D (speed-prioritized pattern). For the charts 2073 and 2074 among the multiple sheets, the CPU 51 obtains data based on the pattern A (accuracy-prioritized pattern).

In the example of FIG. 24, the CPU 51 of the color management apparatus 50 switches data obtaining modes at the boundary of pages.

For a chart consisting of multiple pages, the data obtaining modes may be switched in a single sheet and at the boundary of pages.

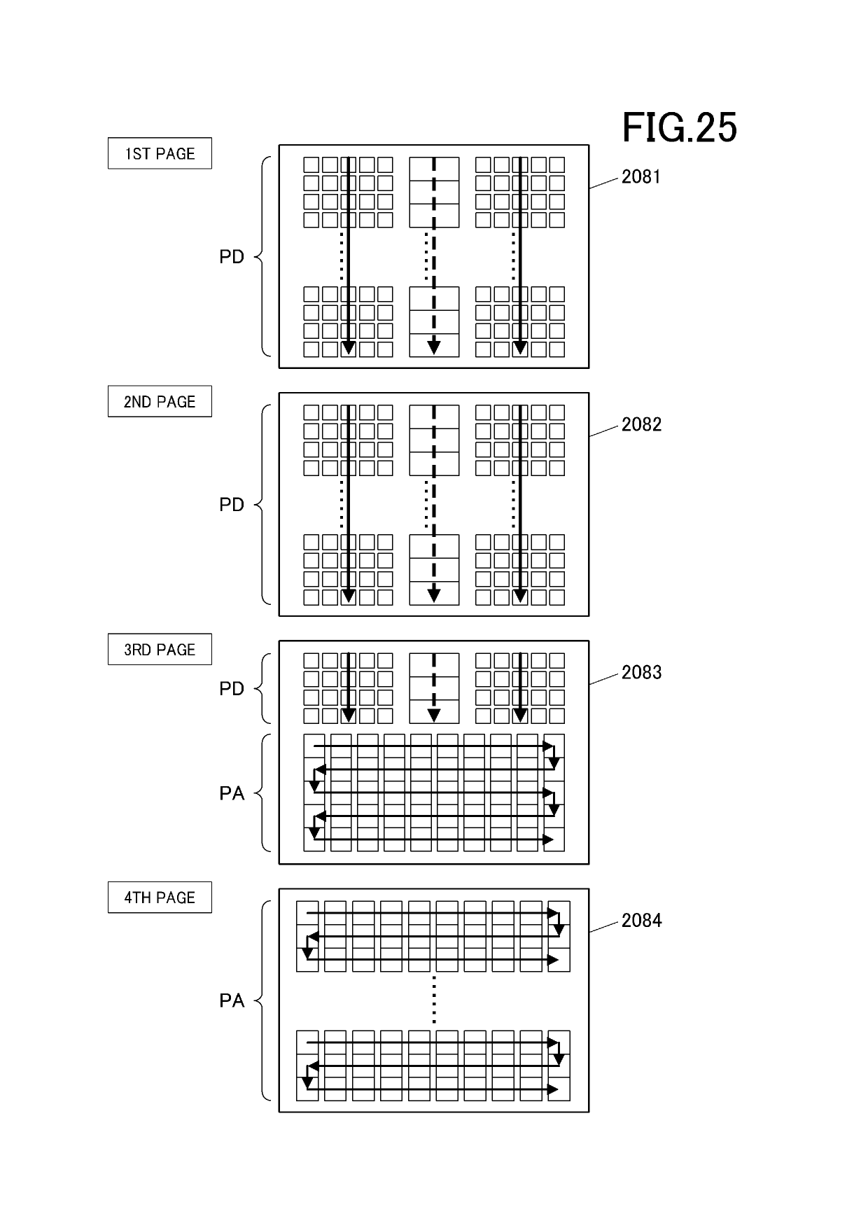

FIG. 25 illustrates an example of charts 2081 to 2084 consisting of multiple pages. In the charts 2081 to 2084, the switching position between the accuracy-prioritized pattern and the speed-prioritized pattern is in a single page. The chart 2081 on the first page and the chart 2082 on the second page include an area PD on which the pattern D (see FIG. 14) is printed. The chart 2083 on the third page includes an area PD on which the pattern D is printed and an area PA on which the pattern A (see FIG. 11) is printed. The chart 2084 on the fourth page includes an area PA on which the pattern A is printed.

The reading apparatus 40 reads the areas PD and PA the same way as reading the chart 206 (see FIG. 23).

For the charts 2081 and 2082, the CPU 51 of the color management apparatus 50 obtains data based on the pattern D (speed-prioritized pattern). For the area PD of the chart 2083, the CPU 51 the CPU 51 obtains data based on the pattern D. For the area PA of the chart 2083, the CPU 51 obtains the data based on the pattern A (accuracy-prioritized pattern). For the chart 2084, the CPU 51 obtains data based on the pattern A.

In the example of FIG. 25, the CPU 51 of the color management apparatus 50 switches the data obtaining modes in the middle of the third page. If the pattern switching position corresponding to the ratio specified by the user does not coincide with the boundary between pages, the CPU 51 forms both the pattern D and the pattern A on the boundary page. On the other pages, either the pattern D or the pattern A is formed.

Herein, a method of setting the ratio between the accuracy-prioritized pattern and the speed-prioritized pattern will be described. For example, when the user selects a pattern to be used for color management in step S4 of the first color management process (see FIG. 18), the ratio between the accuracy-prioritized pattern and the speed-prioritized pattern may be continuously changeable.

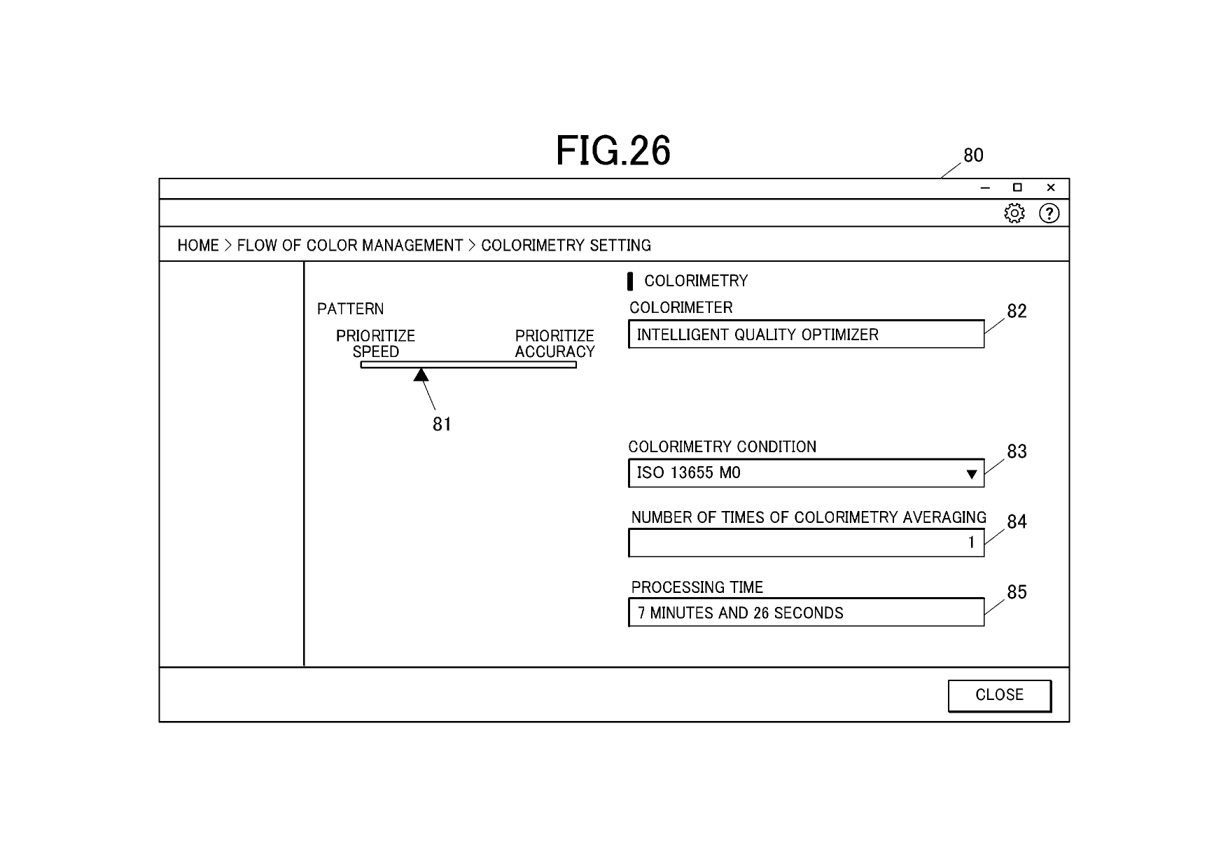

FIG. 26 illustrates an example of a colorimetry setting screen 80 displayed on the display part 53. The colorimetry setting screen 80 includes a slider 81 for adjusting the pattern ratio, a colorimeter display field 82, a colorimetry condition selection field 83, a field 84 for inputting the number of times of colorimetry averaging, and a processing time display field 85.

The user changes the ratio between the accuracy priority and the speed priority in the pattern (chart) by moving the slider 81 to the left or right by operating the operation part 54. For example, the user can adjust the ratio between accuracy priority and speed priority, such as 30% for accuracy priority and 70% for speed priority. The CPU 51 selects a pattern corresponding to the ratio between the accuracy and the speed from predetermined patterns, based on the position of the slider 81. For another example, the CPU 51 may generate a pattern corresponding to the ratio between the accuracy priority and the speed priority, based on the position of the slider 81.

The colorimeter display field 82, the colorimetry condition selection field 83, the field 84 for inputting the number of times of colorimetry averaging, and the processing time display field 85 are the same as the colorimeter display field 62, the colorimetry condition selection field 63, the field 64 for inputting the number of times of colorimetry averaging, and the processing time display field 65 shown in FIG. 20.

When selecting a pattern to be used for color management, the user may be able to select multiple patterns (charts) and continuously change a ratio among the selected patterns to be used.

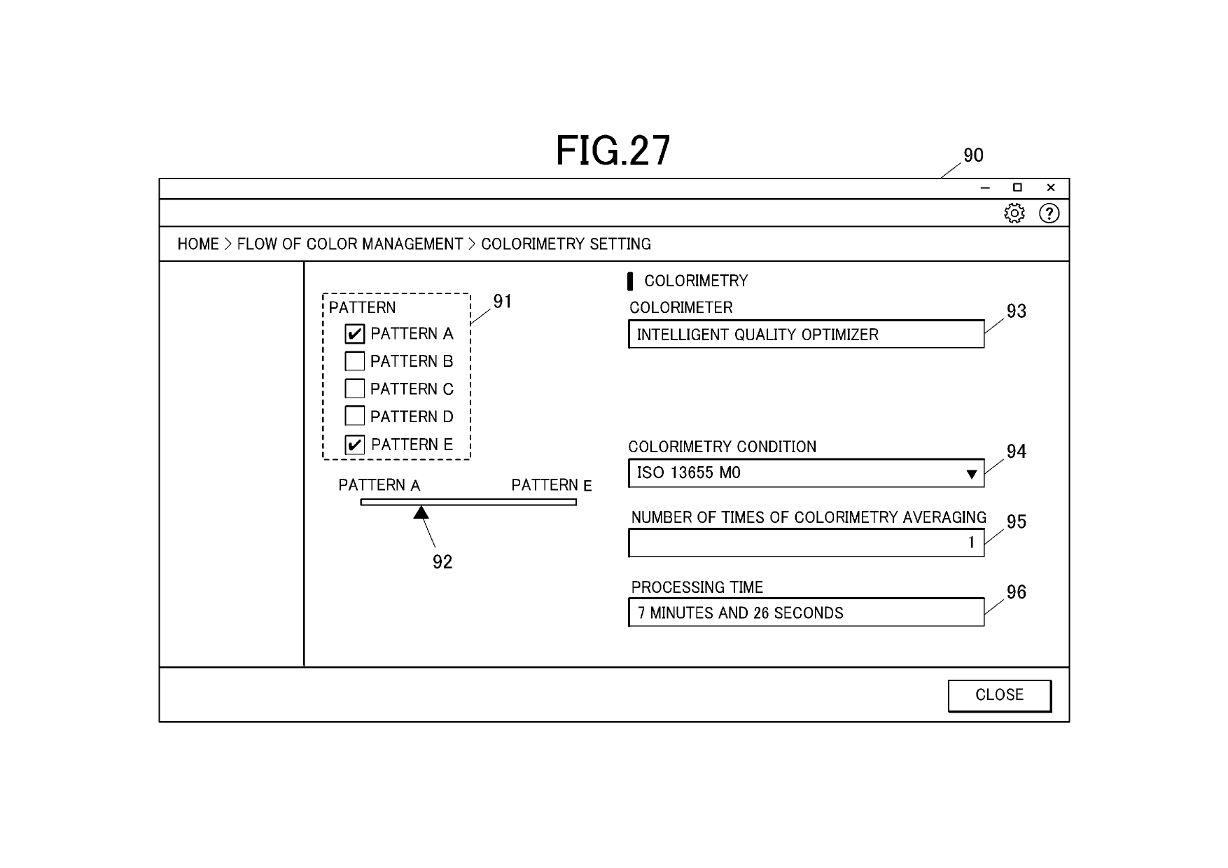

FIG. 27 shows an example of a colorimetry setting screen 90 displayed on the display part 53. The colorimetry setting screen 90 includes a pattern selection field 91, a slider 92 for adjusting the pattern ratio, a colorimeter display field 93, a colorimetry condition selection field 94, a field 95 for inputting the number of times of colorimetry averaging, and a processing time display field 96.

The pattern selection field 91 is for selecting a pattern to be used. For example, patterns having different ratios between data to be read by the colorimeter 45 and data to be read by the scanner 46 are prepared beforehand. In the example of FIG. 27, the pattern A and the pattern E are selected in the pattern selection field 91.

The slider 92 is used to adjust the usage ratio between the patterns selected in the pattern selection field 91. The user changes the ratio between the selected patterns by moving the slider 92 to the right or left by operating the operation part 54.

The colorimeter display field 93, the colorimetry condition selection field 94, the field 95 for inputting the number of times of colorimetry averaging, and the processing time display field 96 are the same as the color measurement display field 62, the colorimetry condition selection field 63, the field 64 for inputting the number of times of colorimetry averaging, and the processing time display field 65 shown in FIG. 20.

Further, the patches to be read by the colorimeter 45 and the patches to be read by the scanner 46 may be continuously changed in the patterns constituting the chart.

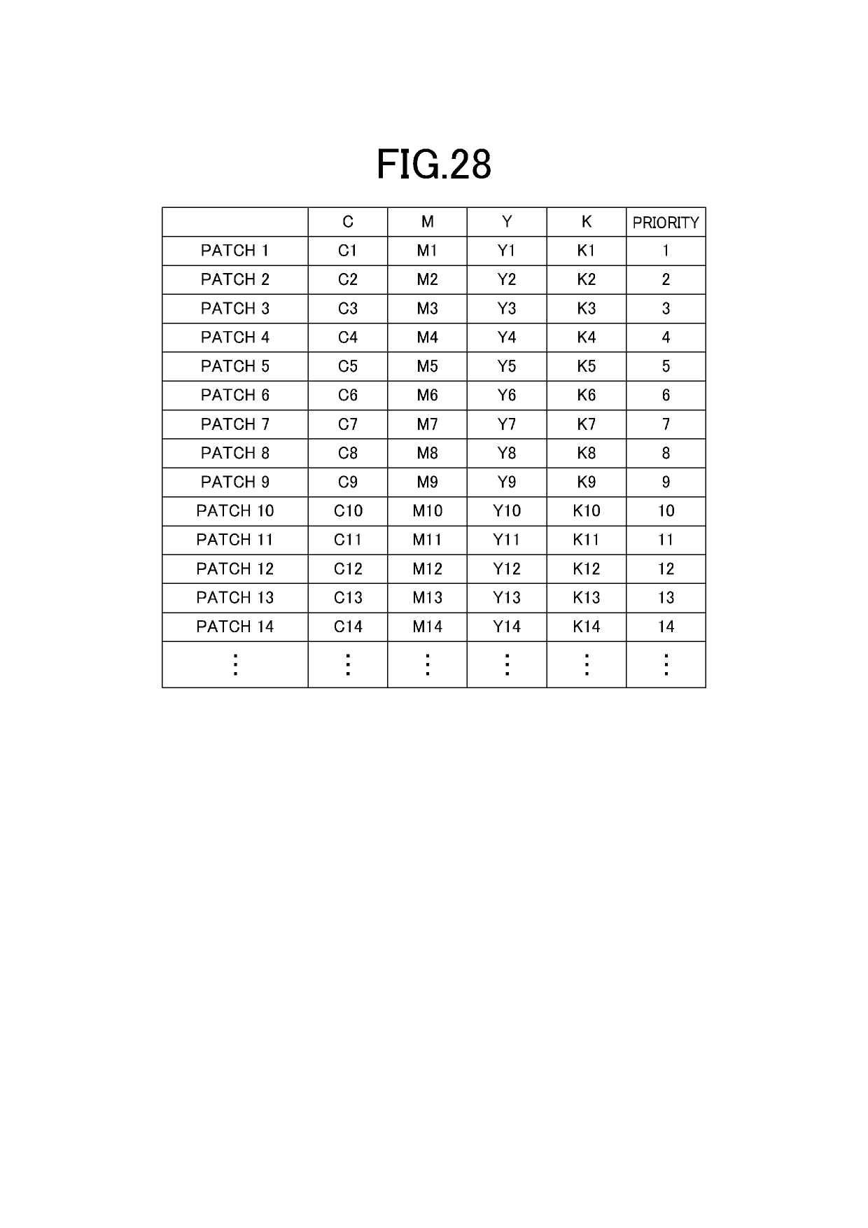

FIG. 28 shows an example of the priority for each patch included in the color management chart. In FIG. 28, a combination of CMYK values constituting the color of each patch is associated with a priority. For example, when changing the pattern based on the ratio set by the user, the CPU 51 of the color management apparatus 50 generates the pattern such that the scanner 46 reads the patches in descending order of priority.

According to the third embodiment, the CPU 51 of the color management apparatus 50 can perform color management corresponding to the balance between a required quality and a delivery date, as with in the first embodiment.

Further, the CPU 51 switches the data obtaining modes in one process related to color management. Thus, the CPU 51 can flexibly cope with a case where the chart for color management includes both the accuracy-prioritized pattern (first pattern) and the speed-prioritized pattern (second pattern).

Further, the CPU 51 switches modes between a mode of obtaining data based on the accuracy-prioritized pattern and a mode of obtaining data based on the speed-prioritized pattern, according to the ratio determined based on the setting by the user. For example, in the colorimetry setting screen 80 in FIG. 26, the user can adjust the ratio between the accuracy priority and the speed priority by moving the slider 81 to the right or left. Further, in the colorimetry setting screen 90 in FIG. 27, the user can select patterns to be used in the pattern selection field 91 and can adjust the ratio among the selected patterns by moving the slider 92 to the right or left.

Further, when a single sheet includes the accuracy-prioritized pattern and the speed-prioritized pattern, the CPU 51 can switch the data obtaining modes for the respective areas in the sheet.

Further, when a chart consists of multiple sheets and each of the sheets has either the accuracy-prioritized pattern or the speed-prioritized pattern, the CPU 51 can switch the data obtaining modes for the respective sheets.

### Fourth Embodiment

Next, a fourth embodiment of the present disclosure will be described.

The configuration of the color management system in the fourth embodiment is the same as that of the color management system 100 in the first embodiment. The same components as the first embodiment are denoted by the same reference signs, and description thereof is omitted. Hereinafter, characteristic configurations and processing of the fourth embodiment will be described.

In the first to third embodiments, the CPU 51 of the color management apparatus 50 changes the data obtaining modes of obtaining data based on the patterns included in the chart. In the fourth embodiment, the image forming apparatus 30 performs printing while switching patterns between the accuracy-prioritized pattern (first pattern) and the speed-prioritized pattern (second pattern) for color management of the image forming apparatus 30. The color management is at least one of color verification, color profile creation, and color correction.

The image forming apparatus 30 includes the image forming section 36 (image forming engine). The image forming apparatus 30 can cooperate with the reading apparatus 40 that is installed at the conveyance path of sheets printed by the image forming section 36 and that includes the colorimeter 45 and the scanner 46.

The CPU 31 of the image forming apparatus 30 performs printing by switching patterns between printing the accuracy-prioritized pattern (first pattern) and the speed-prioritized pattern (second pattern). Information necessary for printing the accuracy-prioritized pattern and the speed-prioritized pattern may be stored in advance in the storage section 32 of the image forming apparatus 30 or may be obtained from the color management apparatus 50. Further, the image forming apparatus 30 may have the functions of the color management apparatus 50 described in the first to third embodiments.

In the accuracy-prioritized pattern, the colorimeter 45 moves by a first width in the sheet width direction and reads all or part of the patches arranged in the sheet width direction to obtain data.

In the speed-prioritized pattern, the colorimeter 45 is stationary in the sheet width direction or moves by a second width narrower than the first width in the sheet width direction; and the scanner 46 reads all or part of the patches arranged in the sheet width direction to obtain data.

The CPU 31 switches modes between a mode for printing the accuracy-prioritized pattern and a mode for printing the speed-prioritized pattern in one process related to color management of the image forming apparatus 30.

The CPU 31 switches modes between a mode of printing the accuracy-prioritized pattern and a mode of printing the speed-prioritized pattern, according to the ratio determined based on the setting by the user. For example, the CPU 31 adjusts the ratio between the accuracy-prioritized pattern and the speed-prioritized pattern in the chart to be used for color management, based on the ratio determined based on the setting by the user.

The CPU 31 may print the accuracy-prioritized pattern on a first area on a single sheet and print the speed-prioritized pattern on a second area different from the first area on the single sheet.

The CPU 31 controls the image forming section 36 (image forming engine) to print patches on multiple sheets as a color management chart.

The CPU 31 may print the accuracy-prioritized pattern on a first sheet among the multiple sheets and print the speed-prioritized pattern on a second sheet different from the first sheet among the multiple sheets.

For the accuracy-prioritized pattern, the CPU 31 may not print the area to be read by the scanner 46 of the reading apparatus 40.

For the speed-prioritized pattern, the CPU 31 may not print the area to be read by the colorimeter 45 of the reading apparatus 40.

In reading the speed-prioritized pattern, the colorimeter 45 of the reading apparatus 40 may be stationary in the sheet width direction.

The CPU 31 prints multiple patches arranged in the sheet width direction as the accuracy-prioritized pattern. Part of the patches are read by the colorimeter 45, and the patches other than the part of the patches read by the colorimeter 45 are read by the scanner 46.

The CPU 31 prints multiple patches arranged in the sheet width direction of the sheet as the speed-prioritized pattern. Part of the patches are read by the scanner 46, and the patches other than the part of the patches read by the scanner 46 are read by the colorimeter 45.

The CPU 31 may print an area to be read by the colorimeter 45, which is used for correcting the data read by the scanner 46, as the speed-prioritized pattern.

According to the fourth embodiment, the CPU 31 of the image forming apparatus 30 prints patterns (chart) to be used for color management of the image forming apparatus 30 by switching patterns between the accuracy-prioritized pattern (first pattern) and the speed-prioritized pattern (second pattern). Therefore, the CPU 51 of the color management apparatus 50 can perform color management in accordance with the balance between a required quality and a delivery date.

### Fifth Embodiment

Next, a fifth embodiment of the present disclosure will be described.

The configuration of the color management system in the fifth embodiment is the same as that of the color management system 100 in the first embodiment. The same components as the first embodiment are denoted by the same reference signs, and description thereof is omitted. Hereinafter, characteristic aspects and processing of the fifth embodiment will be described.

In the first to third embodiments, the CPU 51 of the color management apparatus 50 changes the data obtaining modes of obtaining data based on the patterns included in the chart. In the fifth embodiment, the reading apparatus 40 changes reading modes of reading data for color management of the image forming apparatus 30. The color management is at least one of color verification, color profile creation, and color correction.

The reading apparatus 40 is installed at the conveyance path of sheets printed by the image forming section 36 (image forming engine) of the image forming apparatus 30. The reading apparatus 40 includes the colorimeter 45 and the scanner 46.

The CPU 41 of the reading apparatus 40 switches modes between a mode of obtaining data based on the accuracy-prioritized pattern (first pattern) and a mode of obtaining data based on the speed-prioritized pattern (second pattern).

In the accuracy-prioritized pattern, the colorimeter 45 moves by a first width in the sheet width direction and reads all or part of the patches arranged in the sheet width direction.

In the speed-prioritized pattern, the colorimeter 45 is stationary in the sheet width direction or moves by a second width narrower than the first width in the sheet width direction; and the scanner 46 reads all or part of the patches arranged in the sheet width direction.

The CPU 41 switches modes between a mode of obtaining data based on the accuracy-prioritized pattern and a mode of obtaining data based on the speed-prioritized pattern in one process related to color management.

Based on the ratio determined based on the setting by the user, the CPU 41 switches modes between the mode for obtaining the data based on the accuracy-prioritized pattern and the mode of obtaining the data based on the speed-prioritized pattern.

For a first area on a single sheet, the CPU 41 may obtain the data based on the accuracy-prioritized pattern. For a second area different from the first area on the single sheet, the CPU may obtain the data based on the speed-prioritized pattern.

The CPU 31 of the image forming apparatus 30 controls the image forming section 36 (image forming engine) to print patches as the color management chart on multiple sheets.

For a first sheet among the sheets, the CPU 41 of the reading apparatus 40 may obtain the data based on the accuracy-prioritized pattern; and for a second sheet different from the first sheet among the sheets, the CPU 41 may obtain the data based on the speed-prioritized pattern.

For the accuracy-prioritized pattern, the CPU 41 may not obtain data read by the scanner 46.

For the speed-prioritized pattern, the CPU 41 may not obtain data read by the colorimeter 45.

In reading the speed-prioritized pattern, the CPU 41 may keep the colorimeter 45 stationary in the sheet width direction.

For the accuracy-prioritized pattern, the CPU 41 may obtain data of part of patches arranged in the sheet width direction read by the colorimeter 45 and obtain data of the other patches read by the scanner 46 other than the patches read by the colorimeter 45, among the patches arranged in the sheet width direction.

For the speed-prioritized pattern, the CPU 41 may obtain data of part of patches arranged in the sheet width direction read by the scanner 46 and obtain data of the other patches read by the colorimeter 45 other than the patches read by the scanner 46, among the patches arranged in the sheet width direction.

For the speed-prioritized pattern, the CPU 41 may correct the data read by the scanner 46, based on the data read by the colorimeter 45.

According to the fifth embodiment, the CPU 41 of the reading apparatus 40 switches modes (reading modes) of obtaining data to be used for color management of the image forming apparatus 30. The CPU 41 switches modes between a mode of obtaining data based on the accuracy-prioritized pattern (first pattern) and a mode of obtaining data based on the speed-prioritized pattern (second pattern). Accordingly, the CPU 51 of the color management apparatus 50 can perform color management corresponding to the balance between a required quality and a delivery date.

The embodiments described above are examples of the color management method, the color management apparatus, the program, the image forming apparatus, and the reading apparatus according to the present disclosure. The present disclosure is not limited thereto. The detailed configurations and detailed operations of each apparatus constituting the system can be appropriately modified without departing from the spirit of the present disclosure.

For example, characteristic processes in the embodiments may be combined and executed.

The kinds of patterns and the number of patterns used for color management of the image forming apparatus 30 are not limited to the examples described above. Further, the number or patches constituting a pattern (chart) and the arrangement of patches can be changed as appropriate.

Although the reading apparatus 40 has been described as a different apparatus from the image forming apparatus 30, the reading apparatus 40 (inline reading section 44) may be part of the image forming apparatus 30.

Further, the color management apparatus 50 may be an independent apparatus or may be included in a different apparatus. For example, the color management apparatus 50 may be included in the printer controller 20 or the image forming apparatus 30 or may be included in the reading apparatus 40.

Further, in the first to third embodiments, each process performed by the CPU 51 (color management application) of the color management apparatus 50 may be performed by a different apparatus in the color management system 100 or an apparatus connectable to the color management system 100. Further, each process performed by the CPU 51 of the color management apparatus 50 may be performed by multiple apparatuses in cooperation with each other.

In the embodiments described above, the image forming apparatus 30 forms images using toner by the electrophotographic method. However, the present disclosure is not limited thereto. The image forming apparatus 30 may form images by the inkjet method, for example.

Various kinds of data (e.g., printer information, color management dataset) stored in the storage section 52 of the color management apparatus 50 may be stored in an external device, as long as the data is available to the CPU 51.

The computer-readable medium that stores the program for executing each processes is not limited to the above example. Further, a carrier wave may be used as a medium for providing data of the program via a communication line.

The disclosed embodiments are made for purposes of explanation and example only and not limitation. The scope of the present disclosure should be interpreted by terms of the appended claims.

What is claimed is:

1. A color management method for a color management apparatus that performs color management related to an image forming engine, based on data read by a reading apparatus that includes a colorimeter and a scanner installed at a conveyance path of a sheet printed by the image forming engine and that reads the printed sheet, wherein:
the color management apparatus switches modes between a mode of obtaining data based on a first pattern and a mode of obtaining data based on a second pattern,
for the first pattern, the colorimeter is moved in a sheet width direction by a first width and reads all or part of patches arranged in the sheet width direction, and
for the second pattern, the colorimeter is stationary in the sheet width direction or moves in the sheet width direction by a second width narrower than the first width, and the scanner reads all or part of the patches arranged in the sheet width direction.

2. The color management method according to claim 1, wherein the color management apparatus switches modes between the mode of obtaining the data based on the first pattern and the mode of obtaining the data based on the second pattern in one process related to the color management.

3. The color management method according to claim 2, wherein the color management apparatus switches modes between the mode of obtaining the data based on the first pattern and the mode of obtaining the data based on the second pattern, based on a ratio determined based on setting by a user.

4. The color management method according to claim 2, wherein:
for a first area on a single sheet, the color management apparatus obtains the data based on the first pattern, and
for a second area different from the first area on the single sheet, the color management apparatus obtains the data based on the second pattern.

5. The color management method according to claim 2, wherein:
the image forming engine prints the patches on multiple sheets,
for a first sheet among the sheets, the color management apparatus obtains the data based on the first pattern, and
for a second sheet different from the first sheet among the sheets, the color management apparatus obtains the data based on the second pattern.

6. The color management method according to claim 1, wherein for the first pattern, the color management apparatus does not obtain data read by the scanner.

7. The color management method according to claim 1, wherein for the second pattern, the color management apparatus does not obtain data read by the colorimeter.

8. The color management method according to claim 1, wherein when the reading apparatus reads the second pattern, the colorimeter is stationary in the sheet width direction.

9. The color management method according to claim 1, wherein for the first pattern, the color management apparatus obtains data read by the colorimeter that read part of the patches arranged in the sheet width direction and obtains data read by the scanner that read patches other than the part of the patches read by the colorimeter among the patches arranged in the sheet width direction.

10. The color management method according to claim 1, wherein for the second pattern, the color management apparatus obtains data read by the scanner that read part of the patches arranged in the sheet width direction and obtains data read by the colorimeter that read patches other than the part of the patches read by the scanner among the patches arranged in the sheet width direction.

11. The color management method according to claim 1, wherein for the second pattern, the reading apparatus corrects data read by the scanner, based on data read by the colorimeter.

12. The color management method according to claim 1, wherein:
the color management apparatus performs color management, based on a color management dataset, and
the color management apparatus receives setting of the color management dataset, obtains setting of a mode corresponding to the set color management dataset, and obtains data in a mode indicated by the obtained setting of the mode.

13. The color management method according to claim 12, wherein:
the color management dataset includes the setting of the mode, and
the color management apparatus obtains data in the mode indicated by the setting of the mode included in the set color management dataset.

14. The color management method according to claim 1, wherein the color management is at least one of color verification, color profile creation, and color correction.

15. A color management apparatus comprising a hardware processor that performs the color management method according to claim 1.

16. A non-transitory computer-readable storage medium storing a program for causing a computer that controls a color management apparatus to perform the color management method according to claim 1.

17. An image forming apparatus comprising an image forming engine that performs printing on a sheet, wherein:
the image forming apparatus is capable of cooperating with a reading apparatus that includes a colorimeter and a scanner installed at a conveyance path of the sheet printed by the image forming engine,
the image forming engine switches printing of a first pattern and printing of a second pattern,
for the first pattern, the colorimeter is moved in a sheet width direction by a first width and reads all or part of patches arranged in the sheet width direction to obtain data, and
for the second pattern, the colorimeter is stationary in the sheet width direction or moves in the sheet width direction by a second width narrower than the first width, and the scanner reads all or part of the patches arranged in the sheet width direction to obtain data.

18. A reading apparatus that is installed at a conveyance path of a sheet printed by an image forming engine and that includes a colorimeter and a scanner, wherein:
the reading apparatus switches modes between a mode of obtaining data based on a first pattern and a mode of obtaining data based on a second pattern,
for the first pattern, the colorimeter is moved in a sheet width direction by a first width and reads all or part of patches arranged in the sheet width direction, and
for the second pattern, the colorimeter is stationary in the sheet width direction or moves in the sheet width direction by a second width narrower than the first width, and the scanner reads all or part of the patches arranged in the sheet width direction.
